(19) United States
(12) Patent Application Publication
(10) Pub. No.: US 2024/0400854 A1
(43) Pub. Date: Dec. 5, 2024

(54) COATINGS AND METHODS OF MAKING AND USE THEREOF

(71) Applicant: Ohio State Innovation Foundation, Columbus, OH (US)

(72) Inventors: Emmanouil CHATZAKIS, Hilliard, OH (US); Yael VODOVOTZ, Worthington, OH (US); Kathryn WILLIAMSON, Lausanne (CH); Xin ZHANG, Lexington, MA (US); Xiaoying ZHAO, Beijing (CN)

(21) Appl. No.: 18/687,974

(22) PCT Filed: Aug. 30, 2022
(86) PCT No.: PCT/US22/41953

§ 371 Date: Feb. 29, 2024

Related U.S. Application Data
(60) Provisional application No. 63/239,623, filed on Sep. 1, 2021.

(51) Int. Cl. C09D 163/00; C09D 175/04

(52) U.S. Cl. CPC C09D 163/00; C09D 175/04

(57) ABSTRACT

Disclosed herein are coatings and methods of making and use thereof. For example, disclosed herein are epoxy coatings comprising a (co)polymer derived from an epoxide and an epoxide curing agent; wherein the epoxide comprises an epoxidized biomass oil. Also disclosed herein are non-isocyanate polyurethane coatings comprising a (co)polymer derived from an cyclocarbonate and an amine curing agent; wherein the cyclocarbonate is derived from an epoxidized biomass oil. In the coatings described herein, the epoxidized biomass oil comprises an oil extracted from a biomass, which is an extracted biomass oil, and wherein said extracted biomass oil has been epoxidized; wherein the biomass comprises food waste, coffee beans, or a combination thereof.

### CROSS-REFERENCE TO RELATED APPLICATIONS

This application claims the benefit of priority to U.S. Provisional Application No. 63/239,623, filed Sep. 1, 2021, which is hereby incorporated herein by reference in its entirety.

### BACKGROUND

Coatings are widely applied to various packaging materials including metal, plastic, paper, glass, and others, to provide gas/moisture barriers, grease/oil/stain resistance, corrosion protection, antimicrobial/antioxidant functions, attractive appearance, and more. The coating market is dominated by petroleum-based non-biodegradable epoxy and urethane coatings. There is a growing interest in developing bio-based and/or biodegradable coatings. The compositions, methods, and systems discussed herein addresses these and other needs.

### SUMMARY

In accordance with the purposes of the disclosed compositions, methods, and systems as embodied and broadly described herein, the disclosed subject matter relates to coatings and methods of making and use thereof.

Additional advantages of the disclosed compositions, systems, and methods will be set forth in part in the description which follows, and in part will be obvious from the description. The advantages of the disclosed compositions, systems, and methods will be realized and attained by means of the elements and combinations particularly pointed out in the appended claims. It is to be understood that both the foregoing general description and the following detailed description are exemplary and explanatory only and are not restrictive of the disclosed systems and methods, as claimed.

The details of one or more embodiments of the invention are set forth in the accompanying drawings and the description below. Other features, objects, and advantages of the invention will be apparent from the description and drawings, and from the claims.

### BRIEF DESCRIPTION OF THE FIGURES

The accompanying figures, which are incorporated in and constitute a part of this specification, illustrate several aspects of the disclosure, and together with the description, serve to explain the principles of the disclosure.

FIG. 1. Schematic plan for developing bio-based biodegradable coatings using oil extracted from spent coffee oil.

FIG. 2. An image of a CEM EDGE extractor.

FIG. 3. An image of SCG oil extract.

FIG. 4. An image of epoxidized SCG oil.

FIG. 5. An image of the polymer made from a diamine and the epoxidized SGC.

FIG. 6. An image of the polymer made from a diacid and the epoxidized SGC oil.

FIG. 7. An image of the polymer made from phthalic anhydride and the epoxidized SGC oil.

FIG. 8. An image of the polymer made from phthalic acid and the epoxidized SCG oil.

FIG. 9. Paper samples coated with polymers made with 1:1 epoxidized coffee oil:acetylene dicarboxylic acid and oven cured for various times: 2 hours (left), 6 hours (middle), and 20 hours (right).

FIG. 10. Paper samples coated with polymers made with fumaric acid (left) and acetylene di-acid (right).

FIG. 11. Paper samples coated with polymers made with different ratios of epoxidized coffee oil:acid: 1:1 (left), 1:1.5 (middle), 1:2 (right).

FIG. 12. Shelf life evaluation experimental design.

FIG. 13. Water vapor transmission rate of various samples coated on paper were tested at 40° C., 90% RH, 24 hours. Images of the samples shown below the bar graph (PA=Phthalic anhydride; EXO=epoxidized oil; 1:1-1:1 molar ratio; sample with aq. CA=sample prepared where aqueous citric acid was used as the curing agent).

FIG. 14. Water vapor transmission rate of various samples (ECO=epoxidized coffee oil).

FIG. 15. Water vapor transmission rate of various samples (ECO=epoxidized coffee oil; FA=fumaric acid).

### DETAILED DESCRIPTION

The compositions, methods, and systems described herein may be understood more readily by reference to the following detailed description of specific aspects of the disclosed subject matter and the Examples included therein.

Before the present compositions, methods, and systems are disclosed and described, it is to be understood that the aspects described below are not limited to specific synthetic methods or specific reagents, as such may, of course, vary. It is also to be understood that the terminology used herein is for the purpose of describing particular aspects only and is not intended to be limiting.

Also, throughout this specification, various publications are referenced. The disclosures of these publications in their entireties are hereby incorporated by reference into this application in order to more fully describe the state of the art to which the disclosed matter pertains. The references disclosed are also individually and specifically incorporated by reference herein for the material contained in them that is discussed in the sentence in which the reference is relied upon.

### Definitions

In this specification and in the claims that follow, reference will be made to a number of terms, which shall be defined to have the following meanings.

Throughout the description and claims of this specification the word “comprise” and other forms of the word, such as “comprising” and “comprises,” means including but not limited to, and is not intended to exclude, for example, other additives, components, integers, or steps.

As used in the description and the appended claims, the singular forms “a,” “an,” and “the” include plural referents unless the context clearly dictates otherwise. Thus, for example, reference to “a composition” includes mixtures of two or more such compositions, reference to “an agent” includes mixtures of two or more such agents, reference to “the component” includes mixtures of two or more such components, and the like.

“Optional” or “optionally” means that the subsequently described event or circumstance can or cannot occur, and that the description includes instances where the event or circumstance occurs and instances where it does not.

Ranges can be expressed herein as from “about” one particular value, and/or to “about” another particular value. By “about” is meant within 5% of the value, e.g., within 4, 3, 2, or 1% of the value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

Values can be expressed herein as an “average” value. “Average” generally refers to the statistical mean value.

By “substantially” is meant within 5%, e.g., within 4%, 3%, 2%, or 1%.

“Exemplary” means “an example of” and is not intended to convey an indication of a preferred or ideal embodiment. “Such as” is not used in a restrictive sense, but for explanatory purposes.

It is understood that throughout this specification the identifiers “first” and “second” are used solely to aid in distinguishing the various components and steps of the disclosed subject matter. The identifiers “first” and “second” are not intended to imply any particular order, amount, preference, or importance to the components or steps modified by these terms.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

References in the specification and concluding claims to parts by weight of a particular element or component in a composition denotes the weight relationship between the element or component and any other elements or components in the composition or article for which a part by weight is expressed. Thus, in a compound containing 2 parts by weight of component X and 5 parts by weight component Y, X and Y are present at a weight ratio of 2:5, and are present in such ratio regardless of whether additional components are contained in the compound.

A weight percent (wt. %) of a component, unless specifically stated to the contrary, is based on the total weight of the formulation or composition in which the component is included.

The prefix “bio-” is used herein to designate a material that has been derived from a renewable resource.

The term “renewable resource” refers to a resource that is produced by a natural process at a rate comparable to its rate of consumption (e.g., within a 100-year time frame). The resource can be replenished naturally, or via agricultural techniques.

The term “biobased content” refers to the percent by weight of a material that is composed of biological products or renewable agricultural materials or forestry materials or an intermediate feedstock.

The term “biodegradable” refers to a composite or product capable of being broken down (e.g. metabolized and/or hydrolyzed) by the action of naturally occurring microorganisms, such as fungi and bacteria.

The term “compostable” or “industrially compostable” refers to a composite or product that satisfies requirement, set by ASTM D6868-03.

As used herein, “molecular weight” refers to number average molecular weight as measured by ¹H NMR spectroscopy, unless indicated otherwise.

“Polymer” means a material formed by polymerizing one or more monomers.

The term “(co)polymer” includes homopolymers, copolymers, or mixtures thereof.

The term “(meth)acryl . . . ” includes “acryl . . . ,” “methacryl . . . ,” or mixtures thereof.

### Chemical Definitions

Unless otherwise defined, all technical and scientific terms used herein have the same meaning as commonly understood by one of ordinary skill in the art to which this invention belongs.

The organic moieties mentioned when defining variable positions within the general formulae described herein (e.g., the term “halogen”) are collective terms for the individual substituents encompassed by the organic moiety. The prefix Cₙ-Cₘ preceding a group or moiety indicates, in each case, the possible number of carbon atoms in the group or moiety that follows.

The term “ion,” as used herein, refers to any molecule, portion of a molecule, cluster of molecules, molecular complex, moiety, or atom that contains a charge (positive, negative, or both at the same time within one molecule, cluster of molecules, molecular complex, or moiety (e.g., zwitterions)) or that can be made to contain a charge. Methods for producing a charge in a molecule, portion of a molecule, cluster of molecules, molecular complex, moiety, or atom are disclosed herein and can be accomplished by methods known in the art, e.g., protonation, deprotonation, oxidation, reduction, alkylation, acetylation, esterification, de-esterification, hydrolysis, etc.

The term “anion” is a type of ion and is included within the meaning of the term “ion.” An “anion” is any molecule, portion of a molecule (e.g., zwitterion), cluster of molecules, molecular complex, moiety, or atom that contains a net negative charge or that can be made to contain a net negative charge. The term “anion precursor” is used herein to specifically refer to a molecule that can be converted to an anion via a chemical reaction (e.g., deprotonation).

The term “cation” is a type of ion and is included within the meaning of the term “ion.” A “cation” is any molecule, portion of a molecule (e.g., zwitterion), cluster of molecules, molecular complex, moiety, or atom, that contains a net positive charge or that can be made to contain a net positive charge. The term “cation precursor” is used herein to specifically refer to a molecule that can be converted to a cation via a chemical reaction (e.g., protonation or alkylation).

As used herein, the term “substituted” is contemplated to include all permissible substituents of organic compounds. In a broad aspect, the permissible substituents include acyclic and cyclic, branched and unbranched, carbocyclic and heterocyclic, and aromatic and nonaromatic substituents of organic compounds. Illustrative substituents include, for example, those described below. The permissible substituents can be one or more and the same or different for appropriate organic compounds. For purposes of this disclosure, the heteroatoms, such as nitrogen, can have hydrogen substituents and/or any permissible substituents of organic compounds described herein which satisfy the valencies of the heteroatoms. This disclosure is not intended to be limited in any manner by the permissible substituents of organic compounds. Also, the terms “substitution” or “substituted with” include the implicit proviso that such substitution is in accordance with permitted valence of the substituted atom and the substituent, and that the substitution results in a stable compound, e.g., a compound that does not spontaneously undergo transformation such as by rearrangement, cyclization, elimination, etc.

“Z¹,” “Z²,” “Z³,” and “Z⁴” are used herein as generic symbols to represent various specific substituents. These symbols can be any substituent, not limited to those disclosed herein, and when they are defined to be certain substituents in one instance, they can, in another instance, be defined as some other substituents.

The term “aliphatic” as used herein refers to a non-aromatic hydrocarbon group and includes branched and unbranched, alkyl, alkenyl, or alkynyl groups.

As used herein, the term “alkyl” refers to saturated, straight-chained or branched saturated hydrocarbon moieties. Unless otherwise specified, C₁-C₂₄ (e.g., C₁-C₂₂, C₁-C₂₀, C₁-C₁₈, C₁-C₁₆, C₁-C₁₄, C₁-C₁₂, C₁-C₁₀, C₁-C₈, C₁-C₆, or C₁-C₄) alkyl groups are intended. Examples of alkyl groups include methyl, ethyl, propyl, 1-methyl-ethyl, butyl, 1-methyl-propyl, 2-methyl-propyl, 1,1-dimethyl-ethyl, pentyl, 1-methyl-butyl, 2-methyl-butyl, 3-methyl-butyl, 2,2-dimethyl-propyl, 1-ethyl-propyl, hexyl, 1,1-dimethyl-propyl, 1,2-dimethyl-propyl, 1-methyl-pentyl, 2-methyl-pentyl, 3-methyl-pentyl, 4-methyl-pentyl, 1,1-dimethyl-butyl, 1,2-dimethyl-butyl, 1,3-dimethyl-butyl, 2,2-dimethyl-butyl, 2,3-dimethyl-butyl, 3,3-dimethyl-butyl, 1-ethyl-butyl, 2-ethyl-butyl, 1,1,2-trimethyl-propyl, 1,2,2-trimethyl-propyl, 1-ethyl-1-methyl-propyl, 1-ethyl-2-methyl-propyl, heptyl, octyl, nonyl, decyl, dodecyl, tetradecyl, hexadecyl, eicosyl, tetracosyl, and the like. Alkyl substituents may be unsubstituted or substituted with one or more chemical moieties. The alkyl group can be substituted with one or more groups including, but not limited to, hydroxyl, halogen, acyl, alkyl, alkoxy, alkenyl, alkynyl, aryl, heteroaryl, aldehyde, amino, cyano, carboxylic acid, ester, ether, ketone, nitro, phosphonyl, silyl, sulfo-oxo, sulfonyl, sulfone, sulfoxide, or thiol, as described below, provided that the substituents are sterically compatible and the rules of chemical bonding and strain energy are satisfied.

Throughout the specification “alkyl” is generally used to refer to both unsubstituted alkyl groups and substituted alkyl groups; however, substituted alkyl groups are also specifically referred to herein by identifying the specific substituent(s) on the alkyl group. For example, the term “halogenated alkyl” specifically refers to an alkyl group that is substituted with one or more halides (halogens; e.g., fluorine, chlorine, bromine, or iodine). The term “alkoxyalkyl” specifically refers to an alkyl group that is substituted with one or more alkoxy groups, as described below. The term “alkylamino” specifically refers to an alkyl group that is substituted with one or more amino groups, as described below, and the like. When “alkyl” is used in one instance and a specific term such as “alkylalcohol” is used in another, it is not meant to imply that the term “alkyl” does not also refer to specific terms such as “alkylalcohol” and the like.

This practice is also used for other groups described herein. That is, while a term such as “cycloalkyl” refers to both unsubstituted and substituted cycloalkyl moieties, the substituted moieties can, in addition, be specifically identified herein; for example, a particular substituted cycloalkyl can be referred to as, e.g., an “alkylcycloalkyl.” Similarly, a substituted alkoxy can be specifically referred to as, e.g., a “halogenated alkoxy,” a particular substituted alkenyl can be, e.g., an “alkenylalcohol,” and the like. Again, the practice of using a general term, such as “cycloalkyl,” and a specific term, such as “alkylcycloalkyl,” is not meant to imply that the general term does not also include the specific term.

As used herein, the term “alkenyl” refers to unsaturated, straight-chained, or branched hydrocarbon moieties containing a double bond. Unless otherwise specified, C₂-C₂₄ (e.g., C₂-C₂₂, C₂-C₂₀, C₂-C₁₈, C₂-C₁₆, C₂-C₁₄, C₂-C₁₂, C₂-C₁₀, C₂-C₈, C₂-C₆, or C₂-C₄) alkenyl groups are intended. Alkenyl groups may contain more than one unsaturated bond. Examples include ethenyl, 1-propenyl, 2-propenyl, 1-methylethenyl, 1-butenyl, 2-butenyl, 3-butenyl, 1-methyl-1-propenyl, 2-methyl-1-propenyl, 1-methyl-2-propenyl, 2-methyl-2-propenyl, 1-pentenyl, 2-pentenyl, 3-pentenyl, 4-pentenyl, 1-methyl-1-butenyl, 2-methyl-1-butenyl, 3-methyl-1-butenyl, 1-methyl-2-butenyl, 2-methyl-2-butenyl, 3-methyl-2-butenyl, 1-methyl-3-butenyl, 2-methyl-3-butenyl, 3-methyl-3-butenyl, 1,1-dimethyl-2-propenyl, 1,2-dimethyl-1-propenyl, 1,2-dimethyl-2-propenyl, 1-ethyl-1-propenyl, 1-ethyl-2-propenyl, I-hexenyl, 2-hexenyl, 3-hexenyl, 4-hexenyl, 5-hexenyl, 1-methyl-1-pentenyl, 2-methyl-1-pentenyl, 3-methyl-1-pentenyl, 4-methyl-1-pentenyl, 1-methyl-2-pentenyl, 2-methyl-2-pentenyl, 3-methyl-2-pentenyl, 4-methyl-2-pentenyl, 1-methyl-3-pentenyl, 2-methyl-3-pentenyl, 3-methyl-3-pentenyl, 4-methyl-3-pentenyl, 1-methyl-4-pentenyl, 2-methyl-4-pentenyl, 3-methyl-4-pentenyl, 4-methyl-4-pentenyl, 1,1-dimethyl-2-butenyl, 1,1-dimethyl-3-butenyl, 1,2-dimethyl-1-butenyl, 1,2-dimethyl-2-butenyl, 1,2-dimethyl-3-butenyl, 1,3-dimethyl-1-butenyl, 1,3-dimethyl-2-butenyl, 1,3-dimethyl-3-butenyl, 2,2-dimethyl-3-butenyl, 2,3-dimethyl-1-butenyl, 2,3-dimethyl-2-butenyl, 2,3-dimethyl-3-butenyl, 3,3-dimethyl-1-butenyl, 3,3-dimethyl-2-butenyl, 1-ethyl-1-butenyl, 1-ethyl-2-butenyl, 1-ethyl-3-butenyl, 2-ethyl-1-butenyl, 2-ethyl-2-butenyl, 2-ethyl-3-butenyl, 1,1,2-trimethyl-2-propenyl, 1-ethyl-1-methyl-2-propenyl, 1-ethyl-2-methyl-1-propenyl, and 1-ethyl-2-methyl-2-propenyl. The term “vinyl” refers to a group having the structure —CH═CH₂; 1-propenyl refers to a group with the structure —CH═CH—CH₃; and 2-propenyl refers to a group with the structure —CH₂—CH═CH₂. Asymmetric structures such as (Z¹Z²)C═C(Z³Z⁴) are intended to include both the E and Z isomers. This can be presumed in structural formulae herein wherein an asymmetric alkene is present, or it can be explicitly indicated by the bond symbol C═C. Alkenyl substituents may be unsubstituted or substituted with one or more chemical moieties. Examples of suitable substituents include, for example, alkyl, alkoxy, alkenyl, alkynyl, aryl, heteroaryl, acyl, aldehyde, amino, cyano, carboxylic acid, ester, ether, halide, hydroxyl, ketone, nitro, phosphonyl, silyl, sulfo-oxo, sulfonyl, sulfone, sulfoxide, or thiol, as described below, provided that the substituents are sterically compatible and the rules of chemical bonding and strain energy are satisfied.

As used herein, the term “alkynyl” represents straight-chained or branched hydrocarbon moieties containing a triple bond. Unless otherwise specified, C₂-C₂₄ (e.g., C₂-C₂₄, C₂-C₂₀, C₂-C₁₈, C₂-C₁₆, C₂-C₁₄, C₂-C₁₂, C₂-C₁₀, C₂-C₈, C₂-C₆, or C₂-C₄) alkynyl groups are intended.

Alkynyl groups may contain more than one unsaturated bond. Examples include C₂-C₆-alkynyl, such as ethynyl, 1-propynyl, 2-propynyl (or propargyl), 1-butynyl, 2-butynyl, 3-butynyl, 1-methyl-2-propynyl, 1-pentynyl, 2-pentynyl, 3-pentynyl, 4-pentynyl, 3-methyl-1-butynyl, 1-methyl-2-butynyl, 1-methyl-3-butynyl, 2-methyl-3-butynyl, 1,1-dimethyl-2-propynyl, 1-ethyl-2-propynyl, 1-hexynyl, 2-hexynyl, 3-hexynyl, 4-hexynyl, 5-hexynyl, 3-methyl-1-pentynyl, 4-methyl-1-pentynyl, 1-methyl-2-pentynyl, 4-methyl-2-pentynyl, 1-methyl-3-pentynyl, 2-methyl-3-pentynyl, 1-methyl-4-pentynyl, 2-methyl-4-pentynyl, 3-methyl-4-pentynyl, 1,1-dimethyl-2-butynyl, 1,1-dimethyl-3-butynyl, 1,2-dimethyl-3-butynyl, 2,2-dimethyl-3-butynyl, 3,3-dimethyl-1-butynyl, 1-ethyl-2-butynyl, 1-ethyl-3-butynyl, 2-ethyl-3-butynyl, and 1-ethyl-1-methyl-2-propynyl. Alkynyl substituents may be unsubstituted or substituted with one or more chemical moieties. Examples of suitable substituents include, for example, alkyl, alkoxy, alkenyl, alkynyl, aryl, heteroaryl, acyl, aldehyde, amino, cyano, carboxylic acid, ester, ether, halide, hydroxyl, ketone, nitro, phosphonyl, silyl, sulfo-oxo, sulfonyl, sulfone, sulfoxide, or thiol, as described below.

As used herein, the term “aryl,” as well as derivative terms such as aryloxy, refers to groups that include a monovalent aromatic carbocyclic group of from 3 to 50 carbon atoms. Aryl groups can include a single ring or multiple condensed rings. In some embodiments, aryl groups include C₆-C₁₀ aryl groups. Examples of aryl groups include, but are not limited to, benzene, phenyl, biphenyl, naphthyl, tetrahydronaphthyl, phenylcyclopropyl, phenoxybenzene, and indanyl. The term “aryl” also includes “heteroaryl,” which is defined as a group that contains an aromatic group that has at least one heteroatom incorporated within the ring of the aromatic group. Examples of heteroatoms include, but are not limited to, nitrogen, oxygen, sulfur, and phosphorus. The term “non-heteroaryl,” which is also included in the term “aryl,” defines a group that contains an aromatic group that does not contain a heteroatom. The aryl substituents may be unsubstituted or substituted with one or more chemical moieties. Examples of suitable substituents include, for example, alkyl, alkoxy, alkenyl, alkynyl, aryl, heteroaryl, acyl, aldehyde, amino, cyano, carboxylic acid, ester, ether, halide, hydroxyl, ketone, nitro, phosphonyl, silyl, sulfo-oxo, sulfonyl, sulfone, sulfoxide, or thiol as described herein. The term “biaryl” is a specific type of aryl group and is included in the definition of aryl. Biaryl refers to two aryl groups that are bound together via a fused ring structure, as in naphthalene, or are attached via one or more carbon-carbon bonds, as in biphenyl.

The term “cycloalkyl” as used herein is a non-aromatic carbon-based ring composed of at least three carbon atoms. Examples of cycloalkyl groups include, but are not limited to, cyclopropyl, cyclobutyl, cyclopentyl, cyclohexyl, etc. The term “heterocycloalkyl” is a cycloalkyl group as defined above where at least one of the carbon atoms of the ring is substituted with a heteroatom such as, but not limited to, nitrogen, oxygen, sulfur, or phosphorus. The cycloalkyl group and heterocycloalkyl group can be substituted or unsubstituted. The cycloalkyl group and heterocycloalkyl group can be substituted with one or more groups including, but not limited to, alkyl, alkoxy, alkenyl, alkynyl, aryl, heteroaryl, acyl, aldehyde, amino, cyano, carboxylic acid, ester, ether, halide, hydroxyl, ketone, nitro, phosphonyl, silyl, sulfo-oxo, sulfonyl, sulfone, sulfoxide, or thiol as described herein.

The term “cycloalkenyl” as used herein is a non-aromatic carbon-based ring composed of at least three carbon atoms and containing at least one double bound, i.e., C═C. Examples of cycloalkenyl groups include, but are not limited to, cyclopropenyl, cyclobutenyl, cyclopentenyl, cyclopentadienyl, cyclohexenyl, cyclohexadienyl, and the like. The term “heterocycloalkenyl” is a type of cycloalkenyl group as defined above and is included within the meaning of the term “cycloalkenyl,” where at least one of the carbon atoms of the ring is substituted with a heteroatom such as, but not limited to, nitrogen, oxygen, sulfur, or phosphorus. The cycloalkenyl group and heterocycloalkenyl group can be substituted or unsubstituted. The cycloalkenyl group and heterocycloalkenyl group can be substituted with one or more groups including, but not limited to, alkyl, alkoxy, alkenyl, alkynyl, aryl, heteroaryl, acyl, aldehyde, amino, cyano, carboxylic acid, ester, ether, halide, hydroxyl, ketone, nitro, phosphonyl, silyl, sulfo-oxo, sulfonyl, sulfone, sulfoxide, or thiol as described herein.

The term “cyclic group” is used herein to refer to either aryl groups, non-aryl groups (i.e., cycloalkyl, heterocycloalkyl, cycloalkenyl, and heterocycloalkenyl groups), or both. Cyclic groups have one or more ring systems (e.g., monocyclic, bicyclic, tricyclic, polycyclic, etc.) that can be substituted or unsubstituted. A cyclic group can contain one or more aryl groups, one or more non-aryl groups, or one or more aryl groups and one or more non-aryl groups.

The term “acyl” as used herein is represented by the formula —C(O)Z′ where Z′ can be a hydrogen, hydroxyl, alkoxy, alkyl, alkenyl, alkynyl, aryl, heteroaryl, cycloalkyl, cycloalkenyl, heterocycloalkyl, or heterocycloalkenyl group described above. As used herein, the term “acyl” can be used interchangeably with “carbonyl.” Throughout this specification “C(O)” or “CO” is a shorthand notation for C═O.

The term “acetal” as used herein is represented by the formula (Z¹Z²)C(═OZ³)(═OZ⁴), where Z¹, Z², Z³, and Z⁴ can be, independently, a hydrogen, halogen, hydroxyl, alkyl, alkenyl, alkynyl, aryl, heteroaryl, cycloalkyl, cycloalkenyl, heterocycloalkyl, or heterocycloalkenyl group described above.

The term “alkanol” as used herein is represented by the formula Z¹OH, where Z¹ can be an alkyl, alkenyl, alkynyl, aryl, heteroaryl, cycloalkyl, cycloalkenyl, heterocycloalkyl, or heterocycloalkenyl group described above.

As used herein, the term “alkoxy” as used herein is an alkyl group bound through a single, terminal ether linkage; that is, an “alkoxy” group can be defined as to a group of the formula Z¹—O—, where Z¹ is unsubstituted or substituted alkyl as defined above. Unless otherwise specified, alkoxy groups wherein Z¹ is a C₁-C₂₄ (e.g., C₁-C₂₂, C₁-C₂₀, C₁-C₁₈, C₁-C₁₆, C₁-C₁₄, C₁-C₁₂, C₁-C₁₀, C₁-C₈, C₁-C₆, or C₁-C₄) alkyl group are intended. Examples include methoxy, ethoxy, propoxy, 1-methyl-ethoxy, butoxy, 1-methyl-propoxy, 2-methyl-propoxy, 1,1-dimethyl-ethoxy, pentoxy, 1-methyl-butyloxy, 2-methyl-butoxy, 3-methyl-butoxy, 2,2-di-methyl-propoxy, 1-ethyl-propoxy, hexoxy, 1,1-dimethyl-propoxy, 1,2-dimethyl-propoxy, 1-methyl-pentoxy, 2-methyl-pentoxy, 3-methyl-pentoxy, 4-methyl-penoxy, 1,1-dimethyl-butoxy, 1,2-dimethyl-butoxy, 1,3-dimethyl-butoxy, 2,2-dimethyl-butoxy, 2,3-dimethyl-butoxy, 3,3-dimethyl-butoxy, 1-ethyl-butoxy, 2-ethylbutoxy, 1,1,2-trimethyl-propoxy, 1,2,2-trimethyl-propoxy, 1-ethyl-1-methyl-propoxy, and 1-ethyl-2-methyl-propoxy.

The term “aldehyde” as used herein is represented by the formula —C(O)H. Throughout this specification “C(O)” is a shorthand notation for C═O.

The terms “amine” or “amino” as used herein are represented by the formula —NZ¹Z²Z³, where Z¹, Z², and Z³ can each be substitution group as described herein, such as hydrogen, an alkyl, alkenyl, alkynyl, aryl, heteroaryl, cycloalkyl, cycloalkenyl, heterocycloalkyl, or heterocycloalkenyl group described above.

The terms “amide” or “amido” as used herein are represented by the formula —C(O)NZ¹Z², where Z¹ and Z² can each be substitution group as described herein, such as hydrogen, an alkyl, alkenyl, alkynyl, aryl, heteroaryl, cycloalkyl, cycloalkenyl, heterocycloalkyl, or heterocycloalkenyl group described above.

The term “anhydride” as used herein is represented by the formula Z¹C(O)OC(O)Z² where Z¹ and Z², independently, can be an alkyl, alkenyl, alkynyl, aryl, heteroaryl, cycloalkyl, cycloalkenyl, heterocycloalkyl, or heterocycloalkenyl group described above.

The term “cyclic anhydride” as used herein is represented by the formula:

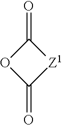

where Z¹ can be an alkyl, alkenyl, alkynyl, aryl, heteroaryl, cycloalkyl, cycloalkenyl, heterocycloalkyl, or heterocycloalkenyl group described above.

The term “azide” as used herein is represented by the formula —N═N═N.

The term “carboxylic acid” as used herein is represented by the formula —C(O)OH.

A “carboxylate” or “carboxyl” group as used herein is represented by the formula —C(O)O⁻.

The term “cyano” as used herein is represented by the formula —CN.

The term “ester” as used herein is represented by the formula —OC(O)Z¹ or —C(O)OZ¹, where Z¹ can be an alkyl, alkenyl, alkynyl, aryl, heteroaryl, cycloalkyl, cycloalkenyl, heterocycloalkyl, or heterocycloalkenyl group described above.

The term “ether” as used herein is represented by the formula Z¹OZ², where Z¹ and Z² can be, independently, an alkyl, alkenyl, alkynyl, aryl, heteroaryl, cycloalkyl, cycloalkenyl, heterocycloalkyl, or heterocycloalkenyl group described above.

The term “epoxy” or “epoxide” as used herein refers to a cyclic ether with a three atom ring and can represented by the formula:

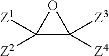

where Z¹, Z², Z³, and Z⁴ can be, independently, an alkyl, alkenyl, alkynyl, aryl, heteroaryl, cycloalkyl, cycloalkenyl, heterocycloalkyl, or heterocycloalkenyl group described above

The term “ketone” as used herein is represented by the formula Z¹C(O)Z², where Z¹ and Z² can be, independently, an alkyl, alkenyl, alkynyl, aryl, heteroaryl, cycloalkyl, cycloalkenyl, heterocycloalkyl, or heterocycloalkenyl group described above.

The term “halide” or “halogen” or “halo” as used herein refers to fluorine, chlorine, bromine, and iodine.

The term “hydroxyl” as used herein is represented by the formula —OH.

The term “nitro” as used herein is represented by the formula —NO₂.

The term “phosphonyl” is used herein to refer to the phospho-oxo group represented by the formula —P(O)OZ¹)₂, where Z¹ can be hydrogen, an alkyl, alkenyl, alkynyl, aryl, heteroaryl, cycloalkyl, cycloalkenyl, heterocycloalkyl, or heterocycloalkenyl group described above.

The term “silyl” as used herein is represented by the formula —SiZ¹Z²Z³, where Z¹, Z², and Z³ can be, independently, hydrogen, alkyl, alkoxy, alkenyl, alkynyl, aryl, heteroaryl, cycloalkyl, cycloalkenyl, heterocycloalkyl, or heterocycloalkenyl group described above.

The term “sulfonyl” or “sulfone” is used herein to refer to the sulfo-oxo group represented by the formula —S(O)₂Z¹, where Z¹ can be hydrogen, an alkyl, alkenyl, alkynyl, aryl, heteroaryl, cycloalkyl, cycloalkenyl, heterocycloalkyl, or heterocycloalkenyl group described above.

The term “sulfide” as used herein is comprises the formula —S—.

The term “thiol” as used herein is represented by the formula —SH.

“R¹,” “R²,” “R³,” “Rⁿ,” etc., where n is some integer, as used herein can, independently, possess one or more of the groups listed above. For example, if R¹ is a straight chain alkyl group, one of the hydrogen atoms of the alkyl group can optionally be substituted with a hydroxyl group, an alkoxy group, an amine group, an alkyl group, a halide, and the like. Depending upon the groups that are selected, a first group can be incorporated within second group or, alternatively, the first group can be pendant (i.e., attached) to the second group. For example, with the phrase “an alkyl group comprising an amino group,” the amino group can be incorporated within the backbone of the alkyl group. Alternatively, the amino group can be attached to the backbone of the alkyl group. The nature of the group(s) that is (are) selected will determine if the first group is embedded or attached to the second group.

Unless stated to the contrary, a formula with chemical bonds shown only as solid lines and not as wedges or dashed lines contemplates each possible stereoisomer or mixture of stereoisomer (e.g., each enantiomer, each diastereomer, each meso compound, a racemic mixture, or scalemic mixture).

### Epoxy Coatings

Disclosed herein are epoxy coatings and methods of making and use thereof. For example, disclosed herein are epoxy coatings comprising a (co)polymer derived from: an epoxide; and an epoxide curing agent.

The epoxide comprises an epoxidized biomass oil. The epoxidized biomass oil comprises an oil extracted from a biomass (e.g. an extracted biomass oil) that has been epoxidized.

The term “biomass,” as used herein, refers to living or dead biological material that can be used in one or more of the disclosed compositions or methods. In the disclosed compositions and methods, the “biomass” can comprise food waste, coffee beans, or a combination thereof; The term “food waste” as used herein includes, but is not limited to, any food or an inedible part of food removed from the food supply chain at any point such that it is not consumed by a human and/or animal. The term “coffee bean” as used herein includes the seeds of a Coffea species in any form. For example, the coffee beans can comprise green coffee beans, roasted coffee beans, spent coffee grounds, or a combination thereof.

In some examples, the biomass comprises coffee beans. In some examples, the coffee beans comprise green coffee beans, roasted coffee beans, spent coffee grounds, or a combination thereof. In some examples, the biomass comprises spent coffee grounds (e.g., ground coffee beans generated after a coffee beverage has been brewed from said ground coffee beans).

The epoxide curing agent can comprise any suitable agent capable of curing an epoxide. For example, the epoxide curing agent can comprise any compound comprising an active hydrogen. For example, the epoxide curing agent can comprise an acid, an amine, an amide, an anhydride, a mercaptan, a phenol, or a combination thereof. As used herein, “an acid” and “the acid” are meant to refer to any compound that includes one or more acid groups. As used herein, “an amine” and “the amine” are meant to refer to any compound that include one or more amine groups. As used herein, “an amide” and “the amide” are meant to refer to any compound that includes one or more amide groups. As used herein, “an anhydride” and “the anhydride” are meant to refer to any compound that includes one or more anhydride groups. As used herein, “a mercaptan” and “the mercaptan” are meant to refer to any compound that includes one or more mercaptan groups. As used herein, “a phenol” and “the phenol” are meant to refer to any compound that includes one or more phenol groups.

In some examples, the epoxide curing agent is derived from the extracted biomass oil, the epoxidized biomass oil, or a combination thereof.

In some examples, the epoxide curing agent comprises phthalic acid, phthalic anhydride, fumaric acid, acetylene dicarboxylic acid, citric acid, or a combination thereof. In some examples, the epoxide curing agent comprises fumaric acid

In some examples, the epoxy coating is bio-based, biodegradable, or a combination thereof.

In some examples, the epoxy coating has an average thickness of from 0.01 millimeters (mm) or more (e.g., 0.02 mm or more, 0.03 mm or more, 0.04 mm or more, 0.05 mm or more, 0.06 mm or more, 0.07 mm or more, 0.08 mm or more, 0.09 mm or more, 0.1 mm or more, 0.15 mm or more, 0.2 mm or more, 0.25 mm or more, 0.3 mm or more, 0.35 mm or more, 0.4 mm or more, 0.45 mm or more, 0.5 mm or more, 0.6 mm or more, 0.7 mm or more, 0.8 mm or more, 0.9 mm or more, 1 mm or more, 1.25 mm or more, 1.5 mm or more, 1.75 mm or more, 2 mm or more, 2.25 mm or more, 2.5 mm or more, 2.75 mm or more, 3 mm or more, 3.5 mm or more, 4 mm or more, 4.5 mm or more, 5 mm or more, or 5.5 mm or more). In some examples, the epoxy coating has an average thickness of 6 mm or less (e.g., 5.5 mm or less, 5 mm or less, 4.5 mm or less, 4 mm or less, 3.5 mm or less, 3 mm or less, 2.75 mm or less, 2.5 mm or less, 2.25 mm or less, 2 mm or less, 1.75 mm or less, 1.5 mm or less, 1.25 mm or less, 1 mm or less, 0.9 mm or less, 0.8 mm or less, 0.7 mm or less, 0.6 mm or less, 0.5 mm or less, 0.45 mm or less, 0.4 mm or less, 0.35 mm or less, 0.3 mm or less, 0.25 mm or less, 0.2 mm or less, 0.15 mm or less, 0.1 mm or less, 0.09 mm or less, 0.08 mm or less, 0.07 mm or less, 0.06 mm or less, 0.05 mm or less, 0.04 mm or less, 0.03 mm or less, or 0.02 mm or less). The average thickness of the epoxy coating can range from any of the minimum values described above to any of the maximum values described above. For example, the epoxy coating can have an average thickness of from 0.01 mm to 6 mm (e.g., from 0.01 mm to 3 mm, from 3 mm to 6 mm, from 0.01 mm to 0.1 mm, from 0.1 mm to 1 mm, from 1 mm to 6 mm, from 0.01 mm to 5.5 mm, from 0.02 mm to 6 mm, from 0.02 mm to 5.5 mm, from 0.01 mm to 5 mm, from 0.01 mm to 2.5 mm, from 0.01 mm to 1 mm, from 0.01 to 0.5 mm, or from 0.05-0.3 mm).

In some examples, the (co)polymer further comprises an acrylic polymer, a siloxane polymer, or a combination thereof.

### Epoxy Coated Substrates

Also disclosed herein are coated substrates comprising: a substrate and a coating on a surface of the substrate, wherein the coating comprises any of the epoxy coatings disclosed herein. The substrate can comprise any suitable material. Also disclosed herein are products or articles of manufacture comprising any of the coated substrates disclosed herein.

In some examples, the coated substrate has a water vapor transmission rate, where in the water vapor transmission rate is measured in grams of water transmitted through the sample with an average thickness of 1 mil and area of 1 inch² (this area is the area that the water vapor transmitted through) within 24 hours (g·mil/24 hr/in²), tested at 38° C. and 90% relative humidity (RH). In some examples, the coated substrate has a water vapor transmission rate of 3 g·mil/24 hr/in² or less (e.g., 2.75 g·mil/24 hr/in² or less, 2.5 g·mil/24 hr/in² or less, 2.25 g·mil/24 hr/in² or less, 2 g·mil/24 hr/in² or less, 1.75 g·mil/24 hr/in² or less, 1.5 g·mil/24 hr/in² or less, 1.25 g·mil/24 hr/in² or less, 1 g·mil/24 hr/in² or less, 0.9 g·mil/24 hr/in² or less, 0.8 g·mil/24 hr/in² or less, 0.7 g·mil/24 hr/in² or less, 0.6 g·mil/24 hr/in² or less, 0.5 g·mil/24 hr/in² or less, 0.4 g·mil/24 hr/in² or less, 0.3 g·mil/24 hr/in² or less, or 0.2 g·mil/24 hr/in² or less). In some examples, the coated substrate has a water vapor transmission rate of 0.1 g·mil/24 hr/in² or more (e.g., 0.2 g·mil/24 hr/in² or more, 0.3 g·mil/24 hr/in² or more, 0.4 g·mil/24 hr/in² or more, 0.5 g·mil/24 hr/in² or more, 0.6 g·mil/24 hr/in² or more, 0.7 g·mil/24 hr/in² or more, 0.8 g·mil/24 hr/in² or more, 0.9 g·mil/24 hr/in² or more, 1 g·mil/24 hr/in² or more, 1.25 g·mil/24 hr/in² or more, 1.5 g·mil/24 hr/in² or more, 1.75 g·mil/24 hr/in² or more, 2 g·mil/24 hr/in² or more, 2.25 g·mil/24 hr/in² or more, 2.5 g·mil/24 hr/in² or more, or 2.75 g·mil/24 hr/in² or more). The water vapor transmission rate of the coated substrate can range from any of the minimum values described above to any of the maximum values described above. For example, the coated substrate can have a water vapor transmission rate of from 0.1 to 3 g·mil/24 hr/in² (e.g., from 0.1 to 1.5 g·mil/24 hr/in², from 1.5 to 3 g·mil/24 hr/in², from 0.1 to 1 g·mil/24 hr/in², from 1 to 2 g·mil/24 hr/in², from 2 to 3 g·mil/24 hr/in², from 0.2 to 3 g·mil/24 hr/in², from 0.1 to 2.75 g·mil/24 hr/in², from 0.2 to 2.75 g·mil/24 hr/in², from 0.1 to 2.5 g·mil/24 hr/in², from 0.1 to 2 g·mil/24 hr/in², from 0.1 to 1.5 g·mil/24 hr/in², or from 0.1 to 0.75 g·mil/24 hr/in²).

In some examples, the substrate comprises paper, paperboard, cardboard, or a combination thereof.

In some examples, the substrate comprises a bioplastic derived from a biopolymer. The biopolymer can comprise any suitable biopolymer. In some examples, the biopolymer comprises a biopolyester. In some examples, the biopolymer comprises a polyhydroxyalkanoate polymer. In some examples, the biopolymer comprises a (co)polymer of one or more monomers selected from lactic acid, 3-hydroxypropionate, 3-hydroxybutyrate, 4-hydroxybutyrate, 4-hydroxyvalerate, 5-hydroxyvalerate, 3-hydroxyhexanoate, 6-hydroxyhexanoate, and 3-hydroxyoctanoate. In some examples, the biopolymer comprises polylactic acid (PLA), poly(3-hydroxybutyrate-co-3-hydroxyvalerate) (PHBV), cellulose, starch-based bioplastics, derivatives thereof, or combinations thereof. In some examples, the biopolymer comprises cellulose or derivatives thereof, such as cellulose esters.

In some examples, the substrate comprises a metal, such as aluminum, steel, or a combination thereof.

In some examples, the substrate comprises wood.

In some examples, the coated substrate is a flooring product.

In some examples, the coated substrate is a food packaging product. For example, the coated substrate can comprise a cup, a bucket, a tray, a plate, a box, a bag, etc.

### Methods of Making the Epoxy Coatings and Epoxy Coated Substrates

Also disclosed herein are methods of making any of the epoxy coatings disclosed herein. The methods can, for example, comprise contacting the epoxide with the epoxide curing agent to form a mixture and curing the mixture.

Also disclosed herein are methods of making any of the coated substrates disclosed herein. The methods can, for example, comprise contacting the epoxide with the epoxide curing agent to form a mixture, disposing the mixture on the surface of the substrate, and curing the mixture on the substrate. The mixture can be applied to the surface by any suitable coating technique, including spraying, rolling, brushing, or spreading. The mixture can be applied in a single coat, or in multiple sequential coats (e.g., in two coats or in three coats) as required for a particular application.

In some examples, the epoxide and the epoxide curing agent are provided in a molar ratio of 0.5:1 or more (curing agent:epoxide) (e.g., 0.6:1 or more, 0.7:1 or more, 0.8:1 or more, 0.9:1 or more, 1:1 or more, 1.5:1 or more, 2:1 or more, 2.5:1 or more, 3:1 or more, 3.5:1 or more, 4:1 or more, or 4.5:1 or more). In some examples, the epoxide and the epoxide curing agent are provided in a molar ratio of 5:1 or less (curing agent:epoxide) (e.g., 4.5:1 or less, 4:1 or less, 3.5:1 or less, 3:1 or less, 2.5:1 or less, 2:1 or less, 1.5:1 or less, 1:1 or less, 0.9:1 or less, 0.8:1 or less, 0.7:1 or less, or 0.6:1 or less). The molar ratio of the epoxide curing agent to the epoxide can range from any of the minimum values described above to any of the maximum values described above. For example, the epoxide and the epoxide curing agent are provided in a molar ratio of from 0.5:1 to 5:1 (curing agent:epoxide) (e.g., from 0.5:1 to 2.5:1, from 2.5:1 to 5:1, from 0.5:1 to 1.5:1, from 1.5:1 to 2.5:1, from 2.5:1 to 3.5:1, from 3.5:1 to 5:1, from 0.6:1 to 5:1, from 0.5:1 to 4.5:1, from 0.6:1 to 4.5:1, from 0.5:1 to 4:1, from 1.5:1 to 2:1, or from 0.5:1 to 1:1). In some examples, the epoxide and the epoxide curing agent are provided in a 1:1 ratio.

In some examples, the mixture is cured for an amount of time of 1 hour or more (e.g., 1.5 hours or more, 2 hours or more, 2.5 hours or more, 3 hours or more, 3.5 hours or more, 4 hours or more, 4.5 hours or more, 5 hours or more, 5.5 hours or more, 6 hours or more, 7 hours or more, 8 hours or more, 9 hours or more, 10 hours or more, 11 hours or more, 12 hours or more, 14 hours or more, 16 hours or more, 18 hours or more, 20 hours or more, 22 hours or more, 24 hours or more, 26 hours or more, 28 hours or more, 30 hours or more, 32 hours or more, 34 hours or more, 36 hours or more, 38 hours or more, 40 hours or more, 42 hours or more, 44 hours or more, or 46 hours or more). In some examples, the mixture is cured for an amount of time of 48 hours or less (e.g., 46 hours or less, 44 hours or less, 42 hours or less, 40 hours or less, 38 hours or less, 36 hours or less, 34 hours or less, 32 hours or less, 30 hours or less, 28 hours or less, 26 hours or less, 24 hours or less, 22 hours or less, 20 hours or less, 18 hours or less, 16 hours or less, 14 hours or less, 12 hours or less, 11 hours or less, 10 hours or less, 9 hours or less, 8 hours or less, 7 hours or less, 6 hours or less, 5.5 hours or less, 5 hours or less, 4.5 hours or less, 4 hours or less, 3.5 hours or less, 3 hours or less, 2.5 hours or less, 2 hours or less, or 1.5 hours or less). The amount of time that the mixture is cured can range from any of the minimum values described above to any of the maximum values described above. For example, the mixture can be cured for an amount of time of from 1 hour to 48 hours (e.g., from 1 hour to 24 hours, from 24 hours to 48 hours, from 1 hour to 12 hours, from 12 hours to 24 hours, from 24 hours to 36 hours, from 36 hours to 48 hours, from 2 hours to 48 hours, from 1 hour to 46 hours, from 2 hours to 46 hours, from 2 hours to 24 hours, from 4 hours to 24 hours, from 6 hours to 24 hours, from 12 hours to 24 hours, or from 18 hours to 22 hours). In some examples, the mixture is cured for 20 hours.

In some examples, the mixture is cured at a temperature of 150° C. or more (e.g., 155° C. or more, 160° C. or more, 165° C. or more, 170° C. or more, 175° C. or more, 180° C. or more, 185° C. or more, 190° C. or more, 195° C. or more, 200° C. or more, 205° C. or more, 210° C. or more, or 215° C. or more). In some examples, the mixture is cured at a temperature of 220° C. or less (e.g., 215° C. or less, 210° C. or less, 205° C. or less, 200° C. or less, 195° C. or less, 190° C. or less, 185° C. or less, 180° C. or less, 175° C. or less, 170° C. or less, 165° C. or less, 160° C. or less, or 155° C. or less). The temperature at which the mixture is cured can range from any of the minimum values described above to any of the maximum values described above. For example, the mixture can be cured at a temperature of from 150° C. to 220° C. (e.g., from 150° C. to 185° C., from 185° C. to 220° C., from 150° C. to 170° C., from 170° C. to 190° C., from 190° C. to 210° C., from 210° C. to 220° C., from 155° C. to 220° C., from 150° C. to 215° C., from 155° C. to 215° C., from 150° C. to 200° C., or from 160° C. to 180° C.). In some examples, the mixture is cured at a temperature of 170° C.

In some examples, the methods further comprise making the epoxidized biomass oil by epoxidizing the extracted biomass oil. Any suitable epoxidation method can be used, such as those known in the art (e.g., epoxidation using peracids, hydrogen peroxide, dioxirane, phase transfer catalyst, etc.). In some examples, epoxidizing the extracted biomass oil comprises contacting the extracted biomass oil with an acid and a peroxide, such as formic acid and hydrogen peroxide.

In some examples, the methods further comprise deriving the epoxide curing agent from the extracted biomass oil, the epoxidized biomass oil, or a combination thereof. For example, when the epoxide curing agent comprises a polyacid, the methods can further comprise polymerizing the epoxidized biomass oil via ring-opening polymerization for form polymerized epoxidized biomass oil, and hydrolyzing the polymerized epoxidized biomass oil to form the polyacid. In certain examples, when the epoxide curing agent comprises a polyamine, the methods can further comprise subjecting the extracted biomass oil to a thiol-ene coupling reaction to form the polyamine.

In some examples, the methods can further comprise extracting the oil from the biomass. Any suitable extraction method can be used, such as those known in the art. In some examples, extracting the oil from the biomass comprises solid phase extraction, liquid-liquid extraction, pressurized fluid extraction, supercritical fluid extraction, mechanical pressing (e.g., cold-pressing), steam distillation, or a combination thereof. In some examples, extracting the oil from the biomass comprises contacting the biomass with supercritical CO₂.

The amount of oil extracted from the biomass can, for example, be 10 wt. % or more based on the total weight of the biomass prior to the extraction (e.g., 11 wt. % or more, 12 wt. % or more, 13 wt. % or more, 14 wt. % or more, 15 wt. % or more, 16 wt. % or more, 17 wt. % or more, 18 wt. % or more, or 19 wt. % or more). In some examples, the amount of oil extracted from the biomass can be 20 wt. % or less based on the total weight of the biomass prior to the extraction (e.g., 19 wt. % or less, 18 wt. % or less, 17 wt. % or less, 16 wt. % or less, 15 wt. % or less, 14 wt. % or less, 13 wt. % or less, 12 wt. % or less, or 11 wt. % or less). The amount of oil extracted from the biomass can range from any of the minimum values described above to any of the maximum values described above. For example, the amount of oil extracted from the biomass can be from 10 to 20 wt. % based on the total weight of the biomass prior to the extraction (e.g., from 10 wt. % to 15 wt. %, from 15 wt. % to 20 wt. %, from 10 wt. % to 12 wt. %, from 12 wt. % to 14 wt. %, from 14 wt. % to 16 wt. %, from 16 wt. % to 18 wt. %, from 18 wt. % to 20 wt. %, from 11 wt. % to 20 wt. %, from 10 wt. % to 19 wt. %, from 11 wt. % to 19 wt. %, from 10 wt. % to 18 wt. %, from 10 wt. % to 16 wt. %, or from 12 wt. % to 14 wt. %).

### Non-Isocyanate Polyurethane Coatings

Also disclosed herein are non-isocyanate polyurethane coatings and methods of making and use thereof. For example, disclosed herein are non-isocyanate polyurethane coatings comprising a (co)polymer derived from: an cyclocarbonate; and an amine curing agent.

As used herein, “a cyclocarbonate” and “the cyclocarbonate” are meant to refer to any compound that includes one or more cyclocarbonate groups. The cyclocarbonate is derived from an epoxidized biomass oil. The epoxidized biomass oil comprises an oil extracted from a biomass (e.g. an extracted biomass oil) that has been epoxidized.

The amine curing agent can comprise any suitable amine capable of curing a cyclocarbonate. As used herein, “an amine” and “the amine” are meant to refer to any compound that include one or more amine groups. In some examples, the amine curing agent is derived from the extracted biomass oil.

The term “biomass,” as used herein, refers to living or dead biological material that can be used in one or more of the disclosed compositions or methods. In the disclosed compositions and methods, the “biomass” can comprise food waste, coffee beans, or a combination thereof; The term “food waste” as used herein includes, but is not limited to, any food or an inedible part of food removed from the food supply chain at any point such that it is not consumed by a human and/or animal. The term “coffee bean” as used herein includes the seeds of a Coffea species in any form. For example, the coffee beans can comprise green coffee beans, roasted coffee beans, spent coffee grounds, or a combination thereof.

In some examples, the biomass comprises coffee beans. In some examples, the coffee beans comprise green coffee beans, roasted coffee beans, spent coffee grounds, or a combination thereof. In some examples, the biomass comprises spent coffee grounds (e.g., ground coffee beans generated after a coffee beverage has been brewed from said ground coffee beans).

In some examples, the non-isocyanate polyurethane coating is bio-based, biodegradable, or a combination thereof.

In some examples, the non-isocyanate polyurethane coating has an average thickness of from 0.01 millimeters (mm) or more (e.g., 0.02 mm or more, 0.03 mm or more, 0.04 mm or more, 0.05 mm or more, 0.06 mm or more, 0.07 mm or more, 0.08 mm or more, 0.09 mm or more, 0.1 mm or more, 0.15 mm or more, 0.2 mm or more, 0.25 mm or more, 0.3 mm or more, 0.35 mm or more, 0.4 mm or more, 0.45 mm or more, 0.5 mm or more, 0.6 mm or more, 0.7 mm or more, 0.8 mm or more, 0.9 mm or more, 1 mm or more, 1.25 mm or more, 1.5 mm or more, 1.75 mm or more, 2 mm or more, 2.25 mm or more, 2.5 mm or more, 2.75 mm or more, 3 mm or more, 3.5 mm or more, 4 mm or more, 4.5 mm or more, 5 mm or more, or 5.5 mm or more). In some examples, the non-isocyanate polyurethane coating has an average thickness of 6 mm or less (e.g., 5.5 mm or less, 5 mm or less, 4.5 mm or less, 4 mm or less, 3.5 mm or less, 3 mm or less, 2.75 mm or less, 2.5 mm or less, 2.25 mm or less, 2 mm or less, 1.75 mm or less, 1.5 mm or less, 1.25 mm or less, 1 mm or less, 0.9 mm or less, 0.8 mm or less, 0.7 mm or less, 0.6 mm or less, 0.5 mm or less, 0.45 mm or less, 0.4 mm or less, 0.35 mm or less, 0.3 mm or less, 0.25 mm or less, 0.2 mm or less, 0.15 mm or less, 0.1 mm or less, 0.09 mm or less, 0.08 mm or less, 0.07 mm or less, 0.06 mm or less, 0.05 mm or less, 0.04 mm or less, 0.03 mm or less, or 0.02 mm or less). The average thickness of the non-isocyanate polyurethane coating can range from any of the minimum values described above to any of the maximum values described above. For example, the non-isocyanate polyurethane coating can have an average thickness of from 0.01 mm to 6 mm (e.g., from 0.01 mm to 3 mm, from 3 mm to 6 mm, from 0.01 mm to 0.1 mm, from 0.1 mm to 1 mm, from 1 mm to 6 mm, from 0.01 mm to 5.5 mm, from 0.02 mm to 6 mm, from 0.02 mm to 5.5 mm, from 0.01 mm to 5 mm, from 0.01 mm to 2.5 mm, from 0.01 mm to 1 mm, from 0.01 to 0.5 mm, or from 0.05-0.3 mm).

In some examples, the (co)polymer further comprises an acrylic polymer, a siloxane polymer, or a combination thereof.

### Non-Isocyanate Polyurethane Coated Substrates

Also disclosed herein are coated substrates comprising: a substrate and a coating on a surface of the substrate, wherein the coating comprises any of the non-isocyanate polyurethane coatings disclosed herein. The substrate can comprise any suitable material. Also disclosed herein are products or articles of manufacture comprising any of the coated substrates disclosed herein.

In some examples, the coated substrate has a water vapor transmission rate, where in the water vapor transmission rate is measured in grams of water transmitted through the sample with an average thickness of 1 mil and area of 1 inch² (this area is the area that the water vapor transmitted through) within 24 hours (g·mil/24 hr/in²), tested at 38° C. and 90% relative humidity (RH). In some examples, the coated substrate has a water vapor transmission rate of 3 g·mil/24 hr/in² or less (e.g., 2.75 g·mil/24 hr/in² or less, 2.5 g·mil/24 hr/in² or less, 2.25 g·mil/24 hr/in² or less, 2 g·mil/24 hr/in² or less, 1.75 g·mil/24 hr/in² or less, 1.5 g·mil/24 hr/in² or less, 1.25 g·mil/24 hr/in² or less, 1 g·mil/24 hr/in² or less, 0.9 g·mil/24 hr/in² or less, 0.8 g·mil/24 hr/in² or less, 0.7 g·mil/24 hr/in² or less, 0.6 g·mil/24 hr/in² or less, 0.5 g·mil/24 hr/in² or less, 0.4 g·mil/24 hr/in² or less, 0.3 g·mil/24 hr/in² or less, or 0.2 g·mil/24 hr/in² or less). In some examples, the coated substrate has a water vapor transmission rate of 0.1 g·mil/24 hr/in² or more (e.g., 0.2 g·mil/24 hr/in² or more, 0.3 g·mil/24 hr/in² or more, 0.4 g·mil/24 hr/in² or more, 0.5 g·mil/24 hr/in² or more, 0.6 g·mil/24 hr/in² or more, 0.7 g·mil/24 hr/in² or more, 0.8 g·mil/24 hr/in² or more, 0.9 g·mil/24 hr/in² or more, 1 g·mil/24 hr/in² or more, 1.25 g·mil/24 hr/in² or more, 1.5 g·mil/24 hr/in² or more, 1.75 g·mil/24 hr/in² or more, 2 g·mil/24 hr/in² or more, 2.25 g·mil/24 hr/in² or more, 2.5 g·mil/24 hr/in² or more, or 2.75 g·mil/24 hr/in² or more). The water vapor transmission rate of the coated substrate can range from any of the minimum values described above to any of the maximum values described above. For example, the coated substrate can have a water vapor transmission rate of from 0.1 to 3 g·mil/24 hr/in² (e.g., from 0.1 to 1.5 g·mil/24 hr/in², from 1.5 to 3 g·mil/24 hr/in², from 0.1 to 1 g·mil/24 hr/in², from 1 to 2 g·mil/24 hr/in², from 2 to 3 g·mil/24 hr/in², from 0.2 to 3 g·mil/24 hr/in², from 0.1 to 2.75 g·mil/24 hr/in², from 0.2 to 2.75 g·mil/24 hr/in², from 0.1 to 2.5 g·mil/24 hr/in², from 0.1 to 2 g·mil/24 hr/in², from 0.1 to 1.5 g·mil/24 hr/in², or from 0.1 to 0.75 g·mil/24 hr/in²).

In some examples, the substrate comprises paper, paperboard, cardboard, or a combination thereof.

In some examples, the substrate comprises wood.

In some examples, the coated substrate is a flooring product.

In some examples, the coated substrate is a food packaging product. For example, the coated substrate can comprise a cup, a bucket, a tray, a plate, a box, a bag, etc.

### Methods of Making the Non-Isocyanate Polyurethane Coatings and Non-Isocyanate Polyurethane Coated Substrates

Also disclosed herein are methods for making the non-isocyanate polyurethane coatings disclosed herein. The methods can, for example, comprise contacting the cyclocarbonate with the amine curing agent to form a mixture and curing the mixture.

Also disclosed herein are methods of making the coated substrates disclosed herein. The methods can, for example, comprise contacting the cyclocarbonate with the amine curing agent to form a mixture, disposing the mixture on the surface of the substrate, and curing the mixture on the substrate. The mixture can be applied to the surface by any suitable coating technique, including spraying, rolling, brushing, or spreading. The mixture can be applied in a single coat, or in multiple sequential coats (e.g., in two coats or in three coats) as required for a particular application.

In some examples, the cyclocarbonate and the amine curing agent are provided in a molar ratio of 0.5:1 or more (curing agent:cyclocarbonate) (e.g., 0.6:1 or more, 0.7:1 or more, 0.8:1 or more, 0.9:1 or more, 1:1 or more, 1.5:1 or more, 2:1 or more, 2.5:1 or more, 3:1 or more, 3.5:1 or more, 4:1 or more, or 4.5:1 or more). In some examples, the e cyclocarbonate and the amine curing agent are provided in a molar ratio of 5:1 or less (curing agent:cyclocarbonate) (e.g., 4.5:1 or less, 4:1 or less, 3.5:1 or less, 3:1 or less, 2.5:1 or less, 2:1 or less, 1.5:1 or less, 1:1 or less, 0.9:1 or less, 0.8:1 or less, 0.7:1 or less, or 0.6:1 or less). The molar ratio of the cyclocarbonate and the amine curing agent can range from any of the minimum values described above to any of the maximum values described above. For example, the cyclocarbonate and the amine curing agent are provided in a molar ratio of from 0.5:1 to 5:1 (curing agent:cyclocarbonate) (e.g., from 0.5:1 to 2.5:1, from 2.5:1 to 5:1, from 0.5:1 to 1.5:1, from 1.5:1 to 2.5:1, from 2.5:1 to 3.5:1, from 3.5:1 to 5:1, from 0.6:1 to 5:1, from 0.5:1 to 4.5:1, from 0.6:1 to 4.5:1, from 0.5:1 to 4:1, from 1.5:1 to 2:1, or from 0.5:1 to 1:1).

In some examples, the mixture is cured for an amount of time of 1 hour or more (e.g., 1.5 hours or more, 2 hours or more, 2.5 hours or more, 3 hours or more, 3.5 hours or more, 4 hours or more, 4.5 hours or more, 5 hours or more, 5.5 hours or more, 6 hours or more, 7 hours or more, 8 hours or more, 9 hours or more, 10 hours or more, 11 hours or more, 12 hours or more, 14 hours or more, 16 hours or more, 18 hours or more, 20 hours or more, 22 hours or more, 24 hours or more, 26 hours or more, 28 hours or more, 30 hours or more, 32 hours or more, 34 hours or more, 36 hours or more, 38 hours or more, 40 hours or more, 42 hours or more, 44 hours or more, or 46 hours or more). In some examples, the mixture is cured for an amount of time of 48 hours or less (e.g., 46 hours or less, 44 hours or less, 42 hours or less, 40 hours or less, 38 hours or less, 36 hours or less, 34 hours or less, 32 hours or less, 30 hours or less, 28 hours or less, 26 hours or less, 24 hours or less, 22 hours or less, 20 hours or less, 18 hours or less, 16 hours or less, 14 hours or less, 12 hours or less, 11 hours or less, 10 hours or less, 9 hours or less, 8 hours or less, 7 hours or less, 6 hours or less, 5.5 hours or less, 5 hours or less, 4.5 hours or less, 4 hours or less, 3.5 hours or less, 3 hours or less, 2.5 hours or less, 2 hours or less, or 1.5 hours or less). The amount of time that the mixture is cured can range from any of the minimum values described above to any of the maximum values described above. For example, the mixture can be cured for an amount of time of from 1 hour to 48 hours (e.g., from 1 hour to 24 hours, from 24 hours to 48 hours, from 1 hour to 12 hours, from 12 hours to 24 hours, from 24 hours to 36 hours, from 36 hours to 48 hours, from 2 hours to 48 hours, from 1 hour to 46 hours, or from 2 hours to 46 hours).

In some examples, the mixture is cured at a temperature of 70° C. or more (e.g., 75° C. or more, 80° C. or more, 85° C. or more, 90° C. or more, 95° C. or more, 100° C. or more, 105° C. or more, 110° C. or more, 115° C. or more, 120° C. or more, 125° C. or more, 130° C. or more, 135° C. or more, 140° C. or more, 145° C. or more, 150° C. or more, 155° C. or more, 160° C. or more, 165° C. or more, 170° C. or more, 175° C. or more, 180° C. or more, 185° C. or more, 190° C. or more, 195° C. or more, 200° C. or more, 205° C. or more, 210° C. or more, or 215° C. or more). In some examples, the mixture is cured at a temperature of 220° C. or less (e.g., 215° C. or less, 210° C. or less, 205° C. or less, 200° C. or less, 195° C. or less, 190° C. or less, 185° C. or less, 180° C. or less, 175° C. or less, 170° C. or less, 165° C. or less, 160° C. or less, 155° C. or less, 150° C. or less, 145° C. or less, 140° C. or less, 135° C. or less, 130° C. or less, 125° C. or less, 120° C. or less, 115° C. or less, 110° C. or less, 105° C. or less, 100° C. or less, 95° C. or less, 90° C. or less, 85° C. or less, 80° C. or less, or 75° C. or less). The temperature at which the mixture is cured can range from any of the minimum values described above to any of the maximum values described above. For example, the mixture can be cured at a temperature of from 70° C. to 220° C. (e.g., from 70° C. to 150° C., from 150° C. to 220° C., from 70° C. to 110° C., from 110° C. to 150° C., from 150° C. to 185° C., from 185° C. to 220° C., from 70° C. to 90° C., from 90° C. to 110° C., from 110° C. to 130° C., from 130° C. to 150° C., from 150° C. to 170° C., from 170° C. to 190° C., from 190° C. to 210° C., from 210° C. to 220° C., from 75° C. to 220° C., from 70° C. to 215° C., from 75° C. to 215° C., from 70° C. to 120° C., from 155° C. to 220° C., from 150° C. to 215° C., from 155° C. to 215° C., from 150° C. to 200° C., or from 160° C. to 180° C.). In some examples, the mixture is cured at a temperature of 170° C.

In some examples, the methods can further comprise deriving the cyclocarbonate from the epoxidized biomass oil. For example, the methods can further comprise coupling CO₂ with the epoxidized biomass oil to make the cyclocarbonate.

In some examples, the methods further comprise making the epoxidized biomass oil by epoxidizing the extracted biomass oil. Any suitable epoxidation method can be used, such as those known in the art (e.g., epoxidation using peracids, hydrogen peroxide, dioxirane, phase transfer catalyst, etc.). In some examples, epoxidizing the extracted biomass oil comprises contacting the extracted biomass oil with an acid and a peroxide, such as formic acid and hydrogen peroxide.

In some examples, the methods further comprise deriving the amine curing agent from the extracted biomass oil. In certain examples, when the amine curing agent comprises a polyamine, the methods can further comprise subjecting the extracted biomass oil to a thiol-ene coupling reaction to form the polyamine.

In some examples, the methods can further comprise extracting the oil from the biomass. Any suitable extraction method can be used, such as those known in the art. In some examples, extracting the oil from the biomass comprises solid phase extraction, liquid-liquid extraction, pressurized fluid extraction, supercritical fluid extraction, mechanical pressing (e.g., cold-pressing), steam distillation, or a combination thereof. In some examples, extracting the oil from the biomass comprises contacting the biomass with supercritical CO₂.

The amount of oil extracted from the biomass can, for example, be 10 wt. % or more based on the total weight of the biomass prior to the extraction (e.g., 11 wt. % or more, 12 wt. % or more, 13 wt. % or more, 14 wt. % or more, 15 wt. % or more, 16 wt. % or more, 17 wt. % or more, 18 wt. % or more, or 19 wt. % or more). In some examples, the amount of oil extracted from the biomass can be 20 wt. % or less based on the total weight of the biomass prior to the extraction (e.g., 19 wt. % or less, 18 wt. % or less, 17 wt. % or less, 16 wt. % or less, 15 wt. % or less, 14 wt. % or less, 13 wt. % or less, 12 wt. % or less, or 11 wt. % or less). The amount of oil extracted from the biomass can range from any of the minimum values described above to any of the maximum values described above. For example, the amount of oil extracted from the biomass can be from 10 to 20 wt. % based on the total weight of the biomass prior to the extraction (e.g., from 10 wt. % to 15 wt. %, from 15 wt. % to 20 wt. %, from 10 wt. % to 12 wt. %, from 12 wt. % to 14 wt. %, from 14 wt. % to 16 wt. %, from 16 wt. % to 18 wt. %, from 18 wt. % to 20 wt. %, from 11 wt. % to 20 wt. %, from 10 wt. % to 19 wt. %, from 11 wt. % to 19 wt. %, from 10 wt. % to 18 wt. %, from 10 wt. % to 16 wt. %, or from 12 wt. % to 14 wt. %).

A number of embodiments of the invention have been described. Nevertheless, it will be understood that various modifications may be made without departing from the spirit and scope of the invention. Accordingly, other embodiments are within the scope of the following claims.

The examples below are intended to further illustrate certain aspects of the systems and methods described herein, and are not intended to limit the scope of the claims.

### EXAMPLES

The following examples are set forth below to illustrate the methods and results according to the disclosed subject matter. These examples are not intended to be inclusive of all aspects of the subject matter disclosed herein, but rather to illustrate representative methods and results. These examples are not intended to exclude equivalents and variations of the present invention which are apparent to one skilled in the art.

Efforts have been made to ensure accuracy with respect to numbers (e.g., amounts, temperature, etc.) but some errors and deviations should be accounted for. Unless indicated otherwise, parts are parts by weight, temperature is in ° C. or is at ambient temperature, and pressure is at or near atmospheric. There are numerous variations and combinations of measurement conditions, e.g., component concentrations, temperatures, pressures and other measurement ranges and conditions that can be used to optimize the described process.

### Example 1—Development of Bio-Based, Industrially Compostable Coatings for Packaging Applications Utilizing Oil Extracted from Spent Coffee Grounds

Description of work: Coatings are widely applied to various packaging materials including metal, plastic, paper, glass, and others, to provide gas/moisture barriers, grease/oil/stain resistance, corrosion protection, antimicrobial/antioxidant functions, attractive appearance, and more (Tharanathan R. Trends in food science & technology 2003, 14 (3), 71-78). The coating market is dominated by petroleum-based non-biodegradable epoxy and urethane coatings (Tharanathan R. Trends in food science & technology 2003, 14 (3), 71-78).

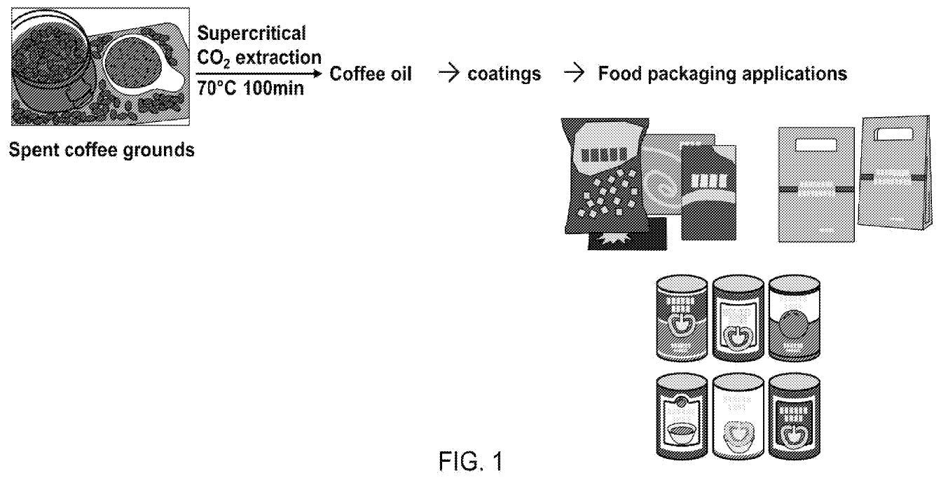

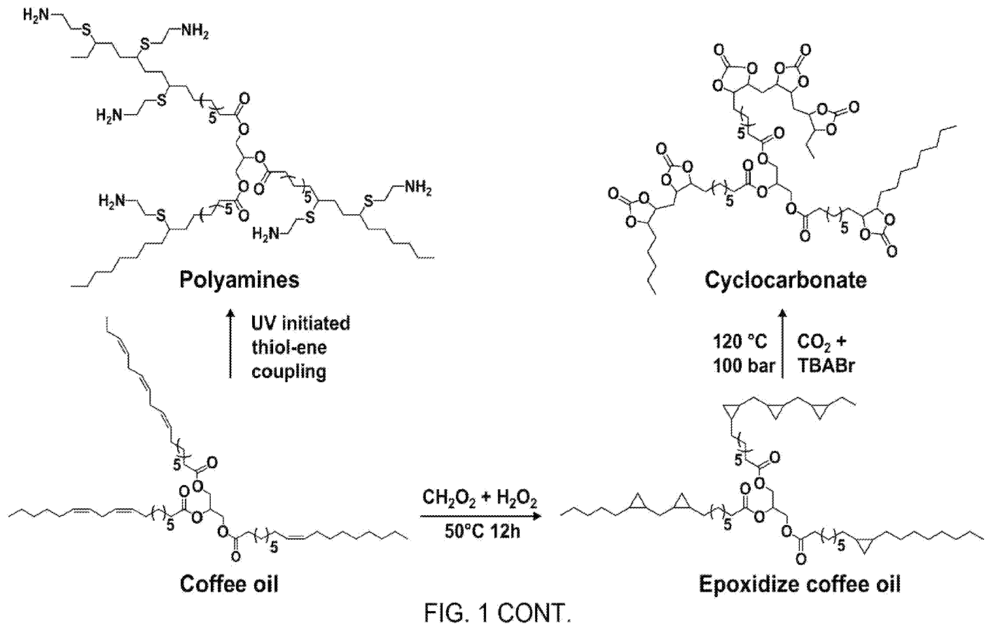

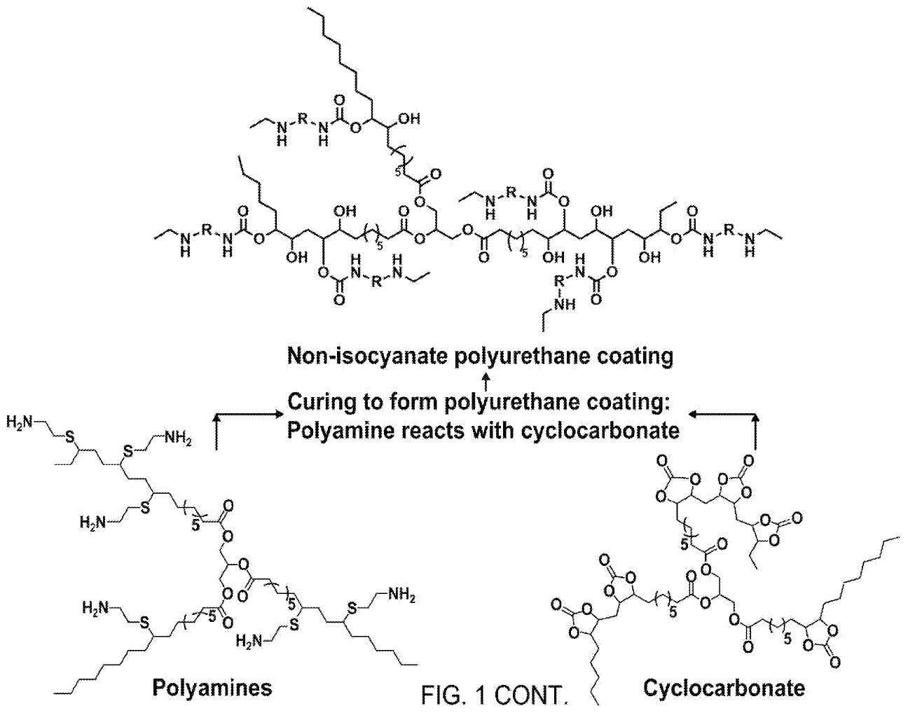

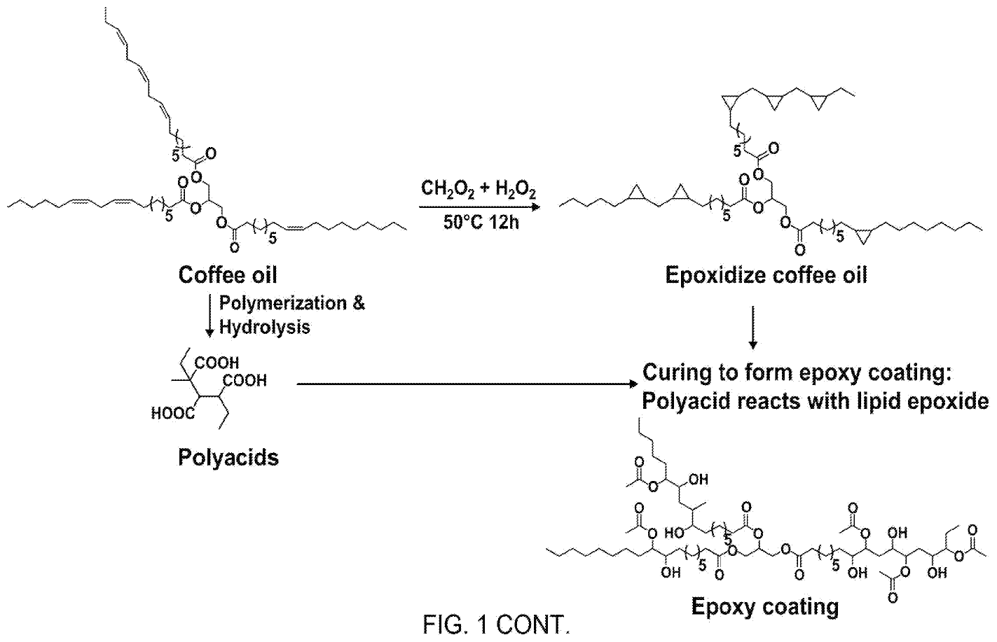

There is a growing interest in developing bio-based biodegradable (refers to industrially compostable in this example) coatings to contribute to fully “green” packaging systems, i.e., every component in the food package is bio-based and biodegradable (Petersen K et al. Trends in food science & technology 1999, 10 (2), 52-68). Therefore, proposed herein is the development of a platform of bio-based biodegradable coatings for different food packaging applications, by value-added use of oil extracted from spent coffee grounds (SCG), the organic residues from brewed coffee (FIG. 1).

Coffee is among the most traded and consumed commodities in the world. Around eight million tons of coffee is consumed globally each year, generating a large amount of SCG, which require a good waste management plan (Caetano N S et al. Clean Technologies and Environmental Policy 2014, 16 (7), 1423-1430). SCG has ˜10-15 wt. % of oil, which is rich in unsaturated fatty acids with double bonds that enable it to undergo various chemical transformations producing low molecular weight polymeric materials with versatile applications, particularly as chief ingredients in coatings (Alam M et al. Arabian Journal of Chemistry 2014, 7 (4), 469-479). The leftover SCG after oil extraction have been used to produce biofuels, biopolymers, antioxidants, and biocomposites (Karmee S K. Waste management 2018, 72, 240-254).

It is hypothesized that SCG oil can be used to produce lipid epoxides (at an efficiency of 95%) by converting its double bonds into epoxy rings through epoxidation (Williamson K et al. Food Research International 2019, 119, 683-692). Bio-based epoxide curing agents, polyacids and polyamines, can also be produced from the coffee oil through hydrolysis and thiol-ene coupling reactions (Hong J et al. ACS Publications: 2015; pp 223-233; Stemmelen M et al. Journal of Polymer Science Part A: Polymer Chemistry 2011, 49 (11), 2434-2444), to form a fully bio-based epoxy coating. Another strategy is to convert epoxide into cyclocarbonate by reacting it with CO₂ (Levina M et al. Polymer Science Series B 2015, 57 (6), 584-592). The cyclocarbonate will then react with bio-based amines or other hardening agents to form bio-based biodegradable non-isocyanate (non-toxic) polyurethane coatings (Levina M et al. Polymer Science Series B 2015, 57 (6), 584-592). The mechanical, thermal, rheological, and barrier properties of the coatings can be tailored to meet different end-use requirements, by manipulating reaction conditions, such as temperature and reactant molarities, and chemical structure of the epoxides and curing agents.

Three food packaging applications, including plastic, paper, and metal packages, of the coatings disclosed herein will be investigated:

1. Metallization primer for polylactic acid (PLA), poly(3-hydroxybutyrate-co-3-hydroxyvalerate) (P/HBV), and other bioplastics. Aluminum metallization has been used to improve bioplastic barrier properties. However, PLA and PHBV bioplastics have poor meltability due to their low adhesion to metals. Since the epoxy coating can covalently bond with alumina (AlOₓ), it can act as a metallization primer to anchor alumina to PLA/PHBV skin to improve their metal adhesion and barrier properties.

2. Barrier and grease/stain resistance layer for papers. Paper materials account for ˜30% of food packaging market, with ˜85% of them being coated with petroleum-based polyethylene, wax, and/or fluorine coatings, to possess adequate moisture/gas barriers and chemical resistance. Bio-based biodegradable epoxy/urethane coatings provide new pathways for fully “green” paper packages.

3. Corrosion protection layer for metal cans. Metal cans are typically coated with an organic layer to prevent reaction with the food. Epoxy resins have been used to coat aluminum/steel cans due to their good stability. Most epoxy coatings are synthesized from bisphenol A (BPA) and epichlorohydrin with potentially toxic effects. BPA-free bio-based biodegradable epoxy coatings provide safe and green alternatives for corrosion protection of metal cans.

Related work: Currently, most of bio-based/biodegradable coatings are derived from chitosan, starch, cellulose, whey/soy proteins, PLA, PHBV, and other renewable materials (Rastogi V K et al. Coatings 2015, 5 (4), 887-930). Coatings from these biopolymers usually have low moisture/gas barriers (Rastogi V K et al. Coatings 2015, 5 (4), 887-930). Nanofillers are incorporated into the coatings to create hierarchical structures to enhance the barriers (Gartner H et al. Applied Surface Science 2015, 332, 488-493; Zheng T et al., Carbohydrate polymers 2017, 157, 1333-1340). Concerns over migration of nanofillers from the coating into the foods need to be addressed (Gartner H et al. Applied Surface Science 2015, 332, 488-493; Zheng T et al., Carbohydrate polymers 2017, 157, 1333-1340).

Epoxy and polyurethane coatings provide better moisture/gas barriers, higher toughness, and better chemical resistance than other biopolymer coatings (Pfister D P et al. ChemSusChem 2011, 4 (6), 703-717; Konwar U et al. Progress in Organic Coatings 2010, 68 (4), 265-273). For example, an epoxy-amine coating was applied to a stretch-blown PET bottle, increasing the oxygen and carbon dioxide barriers of the bottle by 16 times (Sonneveld K. Packaging Technology and Science: An International Journal 2000, 13 (1), 29-35). Research on developing bio-based epoxy and polyurethane coatings from vegetable oils, such as linseed, soybean, cannabis, rapeseed, and maize oils, have been reported (Alam M et al. Arabian Journal of Chemistry 2014, 7 (4), 469-479). The outstanding feature of vegetable oils, i.e., their unique chemical structure with unsaturation sites, hydroxyls, esters, and inherent fluidity, make them “greener” precursors to environment friendly coatings. For example, the presence of ester bonds on the vegetable oils make the obtained epoxy/polyurethane coatings prone to microbial degradation via enzymatic hydrolysis, which is desirable for packaging applications where biodegradability is preferred (Das C K. Thermoplastic Elastomers: Synthesis and Applications. BoD—Books on Demand: 2015).

Epoxidation of vegetable oil using peracids, hydrogen peroxide, dioxirane, phase transfer catalyst, and other techniques has been widely studied (Alam M et al. Arabian Journal of Chemistry 2014, 7 (4), 469-479). Oil-derived epoxies can be cured with suitable curing agents (amines, amides, acids, anhydrides) to yield coatings with have high flexibility, good corrosion resistance, and good barriers, due to the presence of long hydrophobic chains in the oil (Alam M et al. Arabian Journal of Chemistry 2014, 7 (4), 469-479).

Various vegetable oil-based polyols have been used as a precursor to react with isocyanates to form polyurethane coatings with versatile and good thermo-mechanical properties (Liang H et al. Industrial crops and products 2018, 117, 169-178; Kong X et al. Progress in organic coatings 2013, 76 (9), 1151-1160). However, isocyanates are highly toxic and volatile and have harmful health effects (Dalvie M et al. South African journal of science 1999, 95 (8), 316-320). Polyaddition of diamines with dicyclocarbonates derived from vegetable oils, leading to non-isocyanate polyurethanes (NIPUs), provides attractive “greener” synthetic route of polyurethane coatings (Doley S et al. European Polymer Journal 2018, 102, 161-168). Despite the widespread application of vegetable oils in coatings, their potential competition with food production drives research on seeking low-cost oils from agro-food processing waste for coating feedstocks.

How is the proposed work different: This work differs from previous efforts in the following aspects: (1) The bio-based/biodegradable coatings will be developed by value-added use of oil extracted spent coffee grounds, which helps circumvent the food-competition issue of using vegetable oils as coating feedstocks; (2) A platform of coatings with tunable mechanical, thermal, rheological, and barrier properties will be developed to meet different end-use requirement; (3) At least three food packaging applications of the coatings, including plastics, paper, and metal, will be investigated to evaluate the industrial applications of the coatings.

The challenge of this project is to impart barrier properties and protection functions by applying the coatings to different packaging materials in industrially feasible techniques, which requires expertise in food science, chemistry, material science, and chemical engineering. This project will be carried out by combining multidisciplinary expertise crossing above mentioned areas.

The bio-based/biodegradable coatings described herein will increase food product's shelf life and contribute to CO₂ emission reduction, as the precursors needed for coating synthesis will be based on renewable materials. Advantages of the coatings will also include cost reduction, by utilizing food processing waste which supports cost-competitiveness. This project will facilitate selecting the appropriate coatings for specific packaging applications and assist packaging industry in their search for alternative coatings to attain environmental sustainability.

Objectives/Milestones: The goal of this study is to produce bio-based and biodegradable coatings with value-added use of oils extracted from spent coffee grounds; tailor the mechanical, thermal, rheological, and barrier properties of the coatings to meet different end-use requirements; and assess the suitability of the coatings for plastic, paper, metal, and other packaging applications, as follows:
a) Extraction of oil from spent coffee ground.
b) Synthesis of polyacid/polyamine epoxide-curing agent using coffee oil.
c) Synthesis of cyclocarbonate as a polyurethane-coating precursor using coffee oil.
d) Time coating performance to meet different end-use requirement.
e) Assess the suitability of the coatings for plastic, paper, metal packaging applications.
f) Assess the biodegradability/composability of the coatings.

### Project Design and Experimental Plan:

a) Oil Extraction from Spent Coffee Ground and Oil Conversion into Epoxide

Lipids from spent coffee grounds will be extracted using supercritical CO₂ (Williamson K et al. Food Research International 2019, 119, 683-692). The obtained lipids will be converted into multifunctional epoxides through epoxidation with formic acid and hydrogen peroxide as described previously (Williamson K et al. Food Research International 2019, 119, 683-692).

### b) Synthesis of Polyacid/Polyamine Epoxide-Curing Agents

Epoxidized coffee oil will be polymerized via ring-opening polymerization catalyzed by BF₃·OEt₂ under N₂ condition. The polymerized epoxidized coffee oil will be hydrolyzed using NaOH to form polyacids. Coffee oil (unepoxidized), cysteamine chloride, and DMPA dissolved in 1,4-dioxane/ethanol will go through UV initiated thiol-ene coupling reactions to produce polyamines (Stemmelen M et al. Journal of Polymer Science Part A: Polymer Chemistry 2011, 49 (11), 2434-2444).

### c) Synthesis of Cyclocarbonate as a Precursor for Non-Isocyanate Polyurethane Coating

Cyclocarbonates will be synthesized by coupling CO₂ with epoxidized coffee oil with TBABr as a catalyst (Poussard L et al. Macromolecules 2016, 49 (6), 2162-2171). Bio-based amines will be used as a curing agent to form polyurethane coatings (Poussard L et al. Macromolecules 2016, 49 (6), 2162-2171)

### d) Tune Coating Performance to Meet Different End-Use Requirement

The mechanical, thermal, rheological, and barrier properties of the coatings will be tailored by manipulating coating curing conditions, selecting different coating curing agents, and chemical modification of the epoxides such as co-polymerization with acrylic, siloxane, and other polymers.

Mechanical/physical performance, including flexibility and hardness, of the coatings will be measured according to ASTM D2794 and D3363, respectively. Thermal properties including melting, glass transition, and degradation temperatures of the coatings will be tested using differential scanning calorimetry (DSC) and thermogravimetric analysis (TGA). Viscosity will be tested using a rheometer and adjusted to match the viscosity required for roll-to-roll coating. Moisture and oxygen barriers will be tested using a dynamic vapor sorption instrument and a MOCON oxygen permeability tester, respectively.

### e) Assess the Suitability of the Coatings for Plastic, Paper, and Metal Food Packaging Applications.

Plastic: The application of epoxy coating as a primer for PLA/PHBV metallization will be investigated. The epoxy coating will be first applied to the PLA/PHBV skin. Alumina will be vacuum deposited on the epoxy coating layer for form a thin barrier layer. Epoxy will covalently bond with alumina. A (3-aminopropyl) triethoxysilane could be added to create stronger bonding between epoxide and alumina. The adhesion between epoxide and alumina will be measured according to ASTM B571-18.

Paper: Epoxy and polyurethane coatings will be applied to cardboard. Adhesion to cardboard, grease, chemical, water, and thermal resistance of the coatings will be measured according to ASTM F2252, F119-82(2015), F2250-13, D2247-15, and ASTM D2485-18, respectively.

Metal: Epoxy coatings will be applied to aluminum/steel cans. The corrosion of coated metal cans in contact with high acid and salt foods will be evaluated according to ASTM G50-10. Morphology of the coated metals will be characterized using a scanning electron microscope (SEM) and an atomic force microscope (AFM).

### f) Assess the Biodegradability/Composability of the Coatings

Biodegradability/composability of the coatings will be evaluated according to ASTM D6868-03.

### Example 2

Development of bio-based, industrially compostable coatings for paperboard packaging applications utilizing oil extracted from spent coffee grounds.

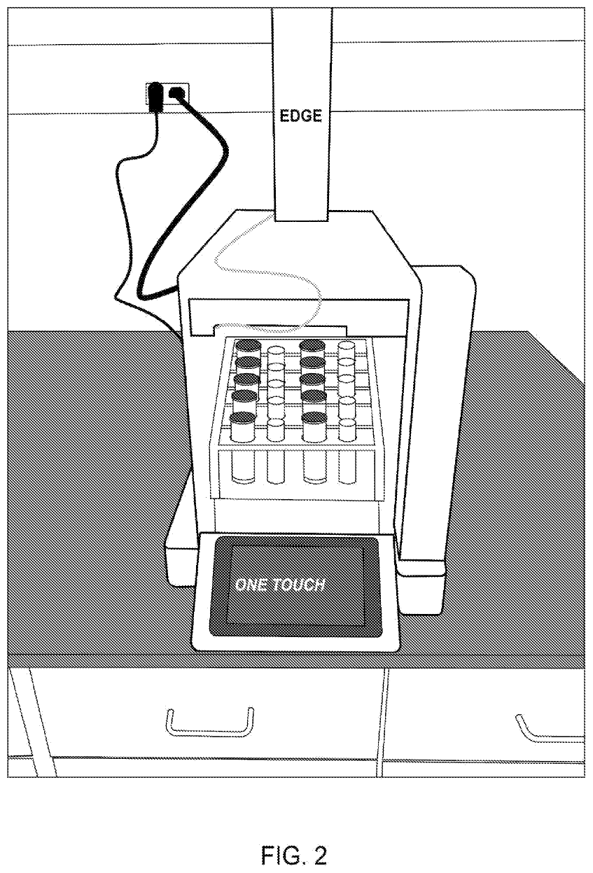

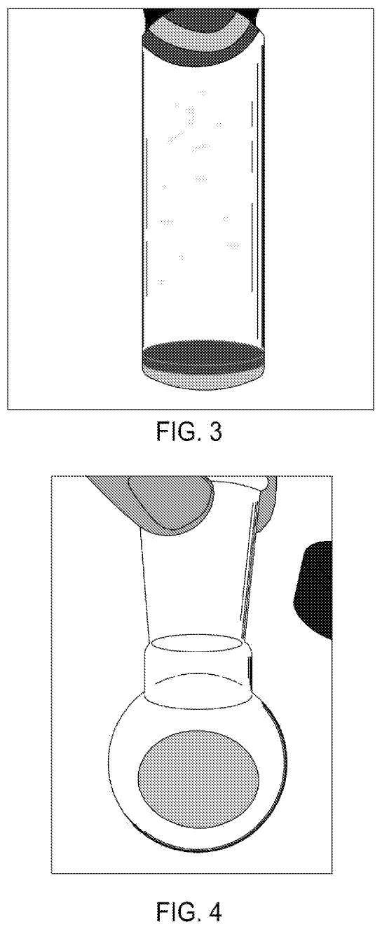

Oil was extracted from spent coffee grounds using a CEM EDGE extractor (FIG. 2). About 100 grams of coffee can be extracted per run. The oil yield of the spent coffee grounds was between 12% and 14%. An image of the oil extracted from spent coffee grounds in shown in FIG. 3.

The extracted coffee oil was then epoxidized with hydrogen peroxide (H₂O₂) and formic acid (HCOOH) for at least 12 hours (1.0:2.0:12, coffee oil:formic acid:H₂O₂, molar ratio). An image of the epoxidized SCG oil is shown in FIG. 4.

The epoxidized SCG oil was then polymerized using phthalic acid, fumaric acid, acetylene di-acid, or amines.

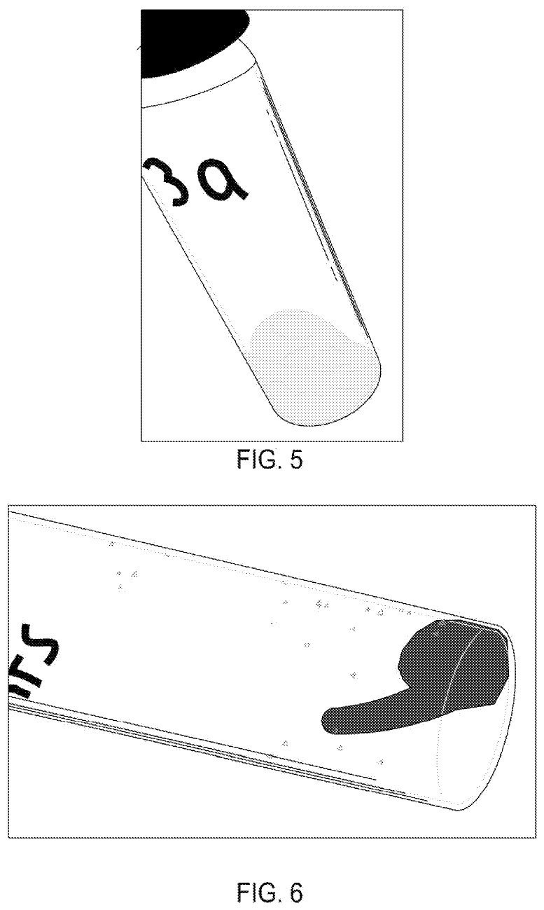

An image of the polymer made from a diamine and the epoxidized SGC oil is shown in FIG. 5.

An image of the polymer made from a diacid and the epoxidized SGC oil is shown in FIG. 6. The ECO (7.0 g, mw=˜980, about 7.1 mmol) and fumaric acid (0.83 g, mw=116, 7.1 mmol, 1 equiv.) were added to a round bottom flask with a stir bar. The mixture was stirred at 150° C. in a heating block for 100 min when the fumaric acid dissolved into the oil and started to partially polymerize, giving a yellow thick glue-like texture.

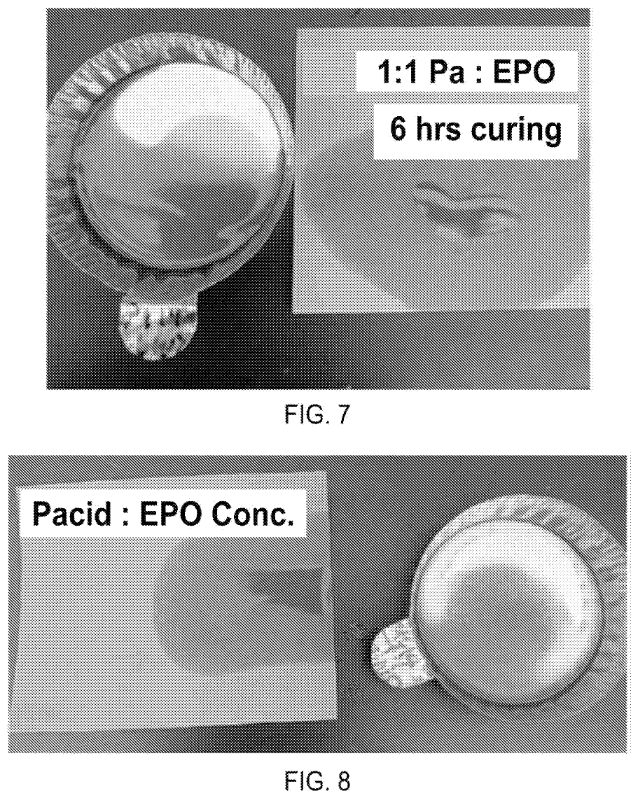

An image of the polymer made from phthalic anhydride and the epoxidized SGC oil is shown in FIG. 7. Briefly, epoxidized SCG oil was mixed with phthalic anhydride at a 1:1 M ratio (Epoxides:anhydride) for 10 minutes at 180° C. Then, the prepolymer was poured onto the paper and cured in an oven at 180° C. for 24 hours. The polymer adhered well to a piece of paper after 6 hours of curing.

An image of the polymer made from phthalic acid and the epoxidized SCG oil is shown in FIG. 8. Briefly, epoxidized SCG oil was mixed with phthalic acid at a 1:1 M ratio (Epoxides:acid) for 10 minutes at 220° C. Then, the prepolymer was poured onto the paper and cured in an oven at 220° C. for 24 hours. This reaction required a higher initial heating temperature for the phthalic acid to melt. A schematic of the reaction between a phthalic acid and an epoxide is shown below in Scheme 1.

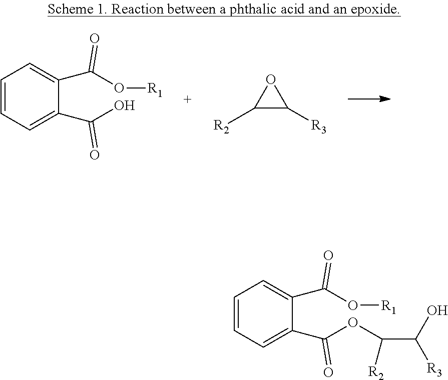

The polymers will be used to create coatings. The suitability of the coatings for paperboard food packaging applications will be assessed.

Coating performance evaluation: The adhesion and barrier properties of the coatings produced above were evaluated and tailored by manipulating coating curing conditions, selecting different coating curing agents, and chemical modification. Moisture barriers were tested using a dynamic vapor sorption instrument.

Three cross linkers were identified in the polymerization process with epoxidized coffee oil: Phthalic acid, fumaric acid, and acetylene dicarboxylic acid. The polymers were cured on the surface of the paper board, and the moisture barrier of polymer films were tested.

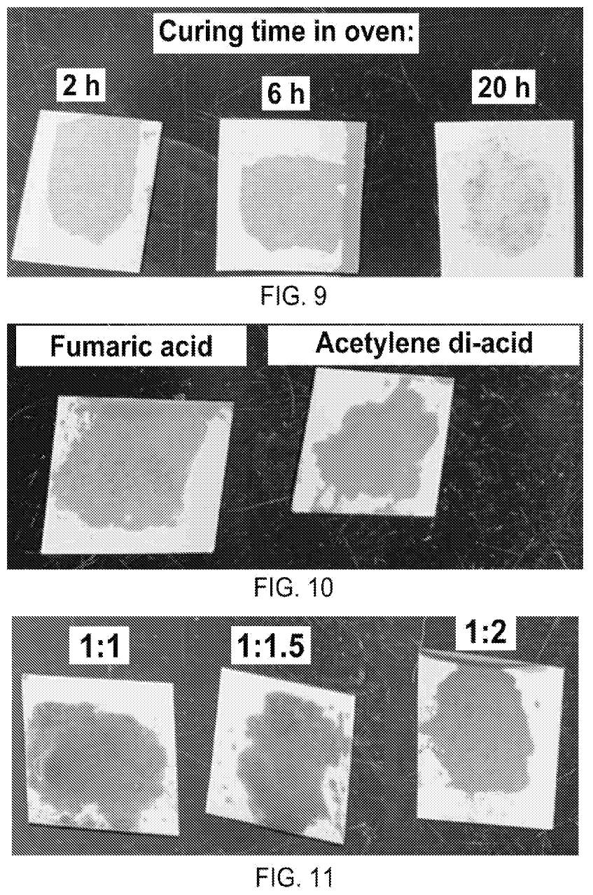

Curing time was investigated with 1:1 epoxidized coffee oil:acetylene dicarboxylic acid. The results are shown in FIG. 9 and Table 1. Longer curing time in the oven resulted in higher barrier properties.

TABLE 1
Effect of oven curing time on water vapor transmission
rates (WVTR) of polymers made from 1:1 epoxidized
coffee oil:acetylene dicarboxylic acid.

| | |
|---|---|
| Curing time | WVTR(g · mil/24 hr/in²) |

| | | |
|---|---|---|
| 2 | h | 2.9 |
| 6 | h | 2.3 |
| 20 | h | 2.0 |

The barrier properties of polymers made using three types of acids (fumaric acid, acetylene diacid, phthalic acid) were tested (curing time 16-20 hours). The results are shown in FIG. 10 and Table 2. Fumaric acid gave the highest barrier properties.

TABLE 2
Effect of acid on water vapor transmission
rates (WVTR) of polymers.

| acid | WVTR(g · mil/24 hr/in²) |
|---|---|
| Fumaric acid | 1.7 |
| Acetylene di-acid | 2.0 |
| Phthalic acid | 2.2 |

The barrier properties of polymers made from different ratios of epoxidized coffee oil:acid were tested. The results are shown in FIG. 11 and Table 3. A 1:1 ratio gave the heisted barrier properties.

TABLE 3
Effect of ratio of epoxidized coffee oil to acid (oil:acid)
on water vapor transmission rates (WVTR) of polymers.

| Oil:acid ratio | WVTR(g · mil/24 hr/in²) |
|---|---|
| 1:1 | 1.7 |
| 1:1.5 | 11.2 |
| 1:2 | 2.4 |

Based on these results, coatings made using a 1:1 ratio of epoxidized coffee oil:fumaric acid cured for 20 hours at 170° C. were selected for further testing.

Oxygen barriers will be tested using a MOCON oxygen permeability tester. Adhesion to cardboard, moisture vapor transmission rate, and oxygen transmission rate of the coatings will be measured according to ASTM F2252, D2247-15, and ASTM D3985-17, respectively.

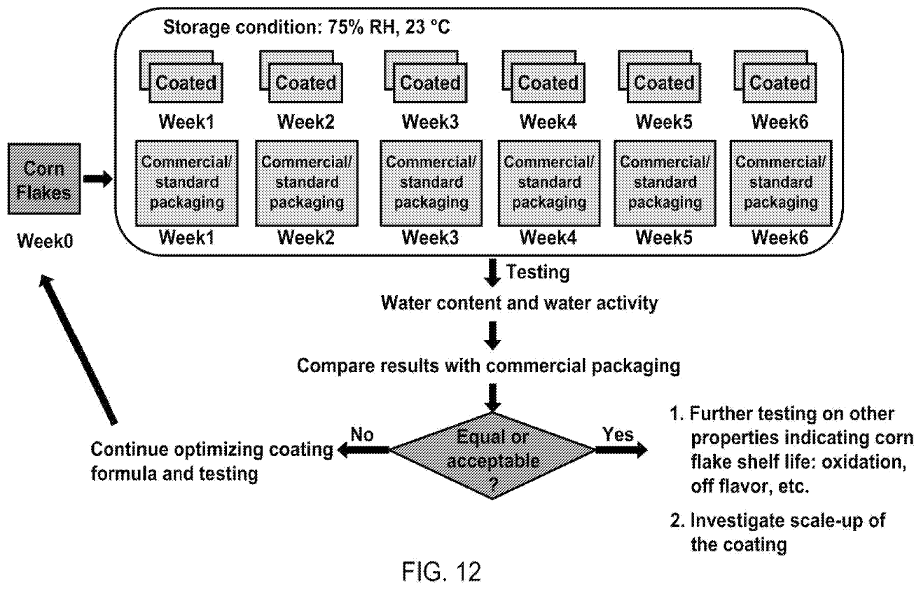

Coating application: The coatings (0.05-0.3 mm thick) were applied to cardboard samples. The coated cardboard was made into pouches and used to pack corn flakes. The packed corn flakes were places in a desiccator with a relative humidity (RH) of 75% at room temperature. The water content and water activity of the packed corn flakes were tested weekly to evaluate the barrier properties of the coated cardboard. Corn flakes packed in their original/commercial packages were also tested under the same conditions as a comparison. Two replicates were used for each test. Samples will be tested for 6 weeks or longer. A schematic of the shelf life evaluation is shown in FIG. 12.

Grease, chemical, and thermal resistance of the coatings will be measured according to F119-82(2015), F2250-13, and ASTM D2485-18, respectively.

### Example 3

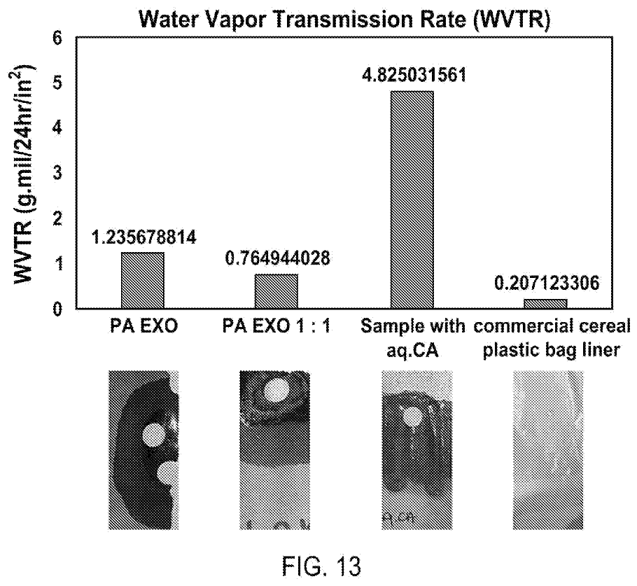

The water vapor transmission rate of various samples coated on paper were tested at 40° C., 90% RH, 24 hours and the results are shown in FIG. 13, with images of the samples shown below the bar graph (PA=Phthalic anhydride; EXO=epoxidized oil; 1:1-1:1 molar ratio; sample with aq. CA=sample prepared where aqueous citric acid was used as the curing agent).

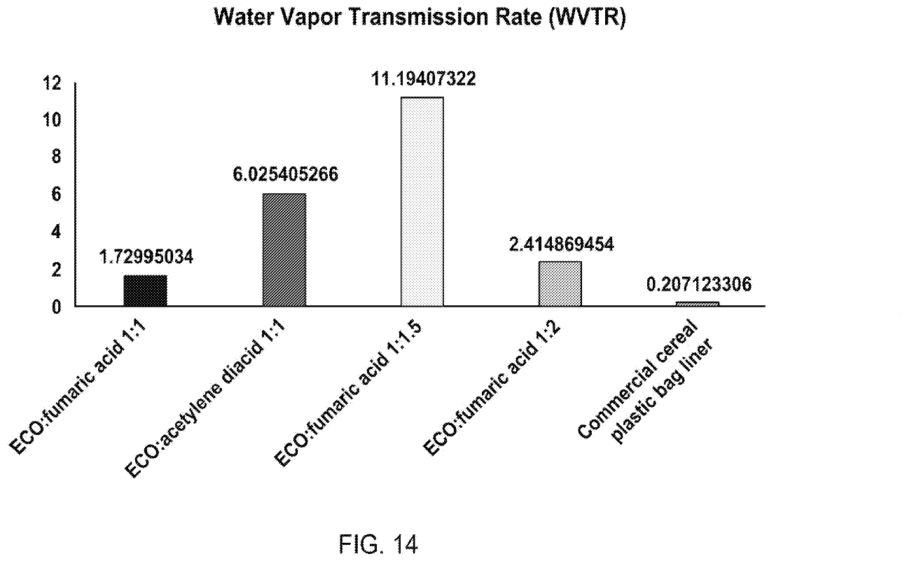

The water vapor transmission rate of various samples were tested and the results are shown in FIG. 14. The WVTR (water vapor transmission rate) was tested at 38° C. and 90% RH. The samples are prepared as below.

Step 1. The ECO (7.0 g, mw=˜980, about 7.1 mmol) and fumaric acid (0.83 g, mw=116, 7.1 mmol, 1 equiv.) were added to a round bottom flask with a stir bar. The mixture was stirred at 150° C. in a heating block for 100 min when the fumaric acid dissolved into the oil and started to partially polymerize, giving a yellow thick glue-like texture.

Step 2. Remove the flask from the heating block and allow it to cool to room temperature and apply the thick glue-like material to the paper board evenly, and then place in 170° C. oven for 20 h (the moisture barrier is slightly better than a 6 h oven curing time). Cool to room temperature and ready to be tested for barriers.

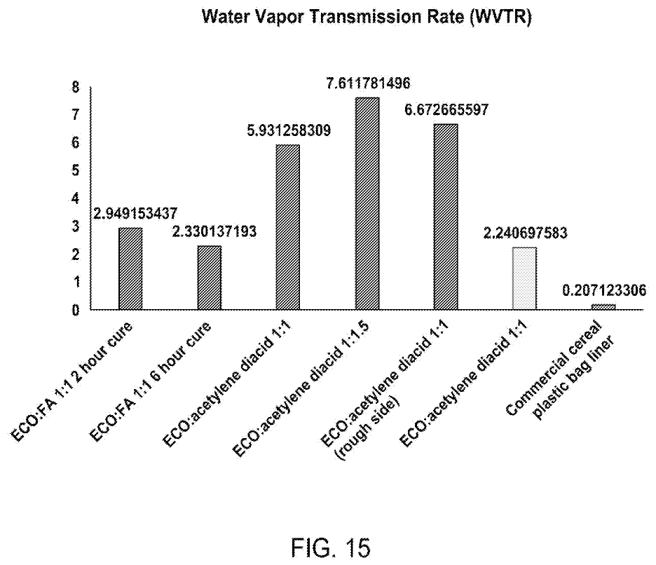

The water vapor transmission rate of various samples were tested and the results are shown in FIG. 15. The samples were prepared as described above. The WVTR (water vapor transmission rate) was tested at 38° C. and 90% RH. For the “rough side” sample, the coating was applied on the rough side of the cardboard, while for all the other samples, the coating was applied on the smooth side.

### Example 4

Described herein are biobased, compostable water impermeable coatings, for example, for cardboard food packaging applications.

Described herein are epoxy resins created from the oil extracted from spec coffee grounds (SCG). SCG is the waste generated following coffee beverage brewing. To create the epoxy resin, SCG oil is extracted using any number of oil extraction methods. The SCG oil is then epoxidized using formic acid and hydrogen peroxide at 40° C. for 12 hours. Next, the epoxides are polymerized by heating in the presence of different reactants (amines, phthalic anhydride, phthalic acid, diacid, etc.), then cured on cardboard packaging to form a coating. The final polymer coating can form a thin, water impermeable layer.

Epoxy resins are thermoset plastic polymers that have a wide range of applications from adhesives to components in plastics, paints, coatings, primers and sealers, flooring, or other construction parts. This epoxy resin is a biobased alternative to current epoxy resins most commonly created from epichlorohydrin (ECH) and bisphenol-A (BPA). Starting with SCG waste to crease this polymer offers a cheap source for epoxy resin polymer creation. Additionally, since this epoxy resin is derived from spent coffee oil, the presence of ester bonds on it make the epoxy coatings prone to microbial degradation via enzymatic hydrolysis, which is desirable for packaging applications where biodegradability is preferred.

Other advantages which are obvious and which are inherent to the invention will be evident to one skilled in the art. It will be understood that certain features and sub-combinations are of utility and may be employed without reference to other features and sub-combinations. This is contemplated by and is within the scope of the claims. Since many possible embodiments may be made of the invention without departing from the scope thereof, it is to be understood that all matter herein set forth or shown in the accompanying drawings is to be interpreted as illustrative and not in a limiting sense.

The methods of the appended claims are not limited in scope by the specific methods described herein, which are intended as illustrations of a few aspects of the claims and any methods that are functionally equivalent are intended to fall within the scope of the claims. Various modifications of the methods in addition to those shown and described herein are intended to fall within the scope of the appended claims. Further, while only certain representative method steps disclosed herein are specifically described, other combinations of the method steps also are intended to fall within the scope of the appended claims, even if not specifically recited. Thus, a combination of steps, elements, components, or constituents may be explicitly mentioned herein or less, however, other combinations of steps, elements, components, and constituents are included, even though not explicitly stated.

1. An epoxy coating comprising a (co)polymer derived from:
an epoxide; and
an epoxide curing agent;
wherein the epoxide comprises an epoxidized biomass oil;
wherein the epoxidized biomass oil comprises an oil extracted from a biomass, which is an extracted biomass oil, and wherein said extracted biomass oil has been epoxidized;
wherein the biomass comprises food waste, coffee beans, or a combination thereof.

2. (canceled)

3. The epoxy coating of claim 1, wherein the epoxide curing agent is derived from the extracted biomass oil, the epoxidized biomass oil, or a combination thereof.

4. The epoxy coating of claim 1, wherein the epoxide curing agent comprises phthalic acid, phthalic anhydride, fumaric acid, acetylene dicarboxylic acid, citric acid, or a combination thereof.

5. (canceled)

6. The epoxy coating of claim 1, wherein the biomass comprises coffee beans.

7. The epoxy coating of claim 6, wherein the coffee beans comprise green coffee beans, roasted coffee beans, spent coffee grounds, or a combination thereof.

8. The epoxy coating of claim 1, wherein the biomass comprises spent coffee grounds.

9. The epoxy coating of claim 1, wherein the epoxy coating is bio-based, biodegradable, or a combination thereof.

10. The coated substrate of claim 13, wherein the epoxy coating has an average thickness of from 0.01 millimeters (mm) to 6 mm.

11. (canceled)

12. The epoxy coating of claim 1, wherein the (co)polymer further comprises an acrylic polymer, a siloxane polymer, or a combination thereof.

13. A coated substrate comprising: a substrate and a coating on a surface of the substrate, wherein the coating comprises the epoxy coating of claim 1.

14. The coated substrate of claim 13, wherein the substrate comprises paper, paperboard, cardboard, or a combination thereof.

15. (canceled)

16. (canceled)

17. The coated substrate of claim 13, wherein the substrate comprises a bioplastic derived from a biopolymer.

18-20. (canceled)

21. The coated substrate of claim 17, wherein the biopolymer comprises polylactic acid (PLA), poly(3-hydroxybutyrate-co-3-hydroxyvalerate) (PHBV), cellulose, starch-based bioplastics, derivatives thereof, or combinations thereof.

22. The coated substrate of claim 13, wherein the substrate comprises a metal.

23. (canceled)

24. The coated substrate of claim 13, wherein the coated substrate is a food packaging product.

25. The coated substrate of claim 13, wherein the substrate comprises wood.

26. The coated substrate of claim 25, wherein the coated substrate is a flooring product.

27. A method of making the epoxy coating of claim 1, the method comprising contacting the epoxide with the epoxide curing agent to form a mixture and curing the mixture.

28. A method of making the coated substrate of claim 13, the method comprising contacting the epoxide with the epoxide curing agent to form a mixture, disposing the mixture on the surface of the substrate, and curing the mixture on the substrate.

29-48. (canceled)

49. A non-isocyanate polyurethane coating comprising a (co)polymer derived from:
a cyclocarbonate; and
an amine curing agent;
wherein the cyclocarbonate is derived from an epoxidized biomass oil;
wherein the epoxidized biomass oil comprises an oil extracted from a biomass, which is an extracted biomass oil, and wherein said extracted biomass oil has been epoxidized;
wherein the biomass comprises food waste, coffee beans, or a combination thereof.

50-81. (canceled)
